(19) United States
(12) Patent Application Publication
(10) Pub. No.: US 2026/0367689 A1
(43) Pub. Date: Nov. 19, 2026

(54) A TARGET POWER CONTROL SCHEME

(71) Applicant: QUALCOMM Incorporated, San Diego, CA (US)

(72) Inventors: Yufan ZHU, Nantong (CN); Yonghai HUANG, Shanghai (CN); Jian YIN, Shanghai (CN); Guifu LI, ShangHai (CN); Zehui GONG, Shanghai (CN); Wangling ZHANG, Shanghai (CN); Matthew Heng ZHANG, Shanghai (CN); Nikhil Kumar KANSAL, San Diego, CA (US); Sumit GEMINI, Delhi (IN); Bin SHU, Shanghai (CN)

(21) Appl. No.: 19/155,221

(22) PCT Filed: May 31, 2023
(86) PCT No.: PCT/CN2023/097350

§ 371 Date: Aug. 8, 2025

(30) Foreign Application Priority Data
Feb. 10, 2023 (WO) PCT/CN2023/075371

(51) Int. Cl. G06F 1/3218; G05B 11/42; G06F 1/324; G09G 5/00

(52) U.S. Cl. CPC G06F 1/3218; G05B 11/42; G06F 1/324; G09G 5/003; G09G 2330/021; G09G 2340/0435

(57) ABSTRACT

Various embodiments include systems and methods for controlling power in a computing device based on frames per second (FPS) displayed on the computing device. A computing device may be use the combination of power control and FPS control in a cascaded PID loop to enhance a device's or software application's stability and/or performance. A cascaded PID loop may include multiple PID controllers organized hierarchically so that the output of one PID controller is used as the input (or set point) for a subsequent PID controller. This cascaded configuration may improve control or performance by reducing variability, enhancing response to disturbances, and enabling more conservative tuning of the outer loop in comparison to single-loop control systems.

### RELATED APPLICATIONS

This application is a continuation-in-part (CIP) of PCT international application no. PCT/CN2023/075371, entitled “A Frames Per Second (FPS) Control Scheme” filed 10 Feb. 2023, the entire contents of which is hereby incorporated by reference for all purposes.

### BACKGROUND

Resource-constrained computing devices, such as smartphones, are being increasingly used for video games or other animated applications. An important aspect of the user experience with these devices is frames per second (FPS), which refers to the number of images (frames) that are displayed on the screen per second.

A high FPS rate means that the game or animation is running smoothly, while a low FPS rate may result in a choppy or laggy experience. A stable FPS means that the rate of frames being displayed on the screen is consistent and does not fluctuate frequently, which is important for providing a smooth and enjoyable gaming experience. A game with a stable FPS rate of 60, for example, would display 60 images on the screen every second.

### SUMMARY

Various aspects include methods of stabilizing frames per second (FPS) displayed on a computing device, which may include applying a target FPS value and a current FPS value to a Proportional-Integral-Derivative (PID) controller to generate a frequency adjustment value and adjusting a processing frequency based on the frequency adjustment value.

Some aspects may include determining an updated current FPS value, determining whether the updated current FPS value is within a threshold range of the target FPS value, and repeating the operations of applying the target FPS value and the current FPS value to the PID controller to generate the frequency adjustment value, adjusting the processing frequency based on the frequency adjustment value, determining the updated current FPS value, and determining whether the updated current FPS value is within the threshold range of the target FPS value until the current FPS value is within the threshold range of the target FPS value.

In some aspects, adjusting the processing frequency based on the frequency adjustment value may include setting maximum and minimum frequency values of a processing cluster. In some aspects, applying the target FPS value and the current FPS value to the PID controller to generate the frequency adjustment value may include determining an error value based on a difference between the current FPS value and the target FPS value, applying the error value to a proportional term, integral term, and derivative term to obtain an output control variable, and determining the frequency adjustment value based on the output control variable. In some aspects, determining the frequency adjustment value based on the output control variable may include determining the frequency adjustment value of each processing unit based on the output control variable and the load ratio of each processing unit.

Some aspects may include determining an updated frequency adjustment value based on an output control variable, a frequency value of each processing unit, and a load ratio of each processing unit, and adjusting the processing frequency based on the updated frequency adjustment value. Some aspects may further include repeatedly performing operations of determining the updated frequency adjustment value based on the output control variable, the frequency value of each processing unit, and the load ratio of each processing unit, and adjusting the processing frequency based on the updated frequency adjustment value until the current FPS value is within a threshold range of the target FPS value.

Further aspects include methods of controlling power in a computing device by controlling the frames per second (FPS) displayed on the computing device. In some aspects, the methods may include applying a target power value and a current power value to a Proportional-Integral-Derivative (PID) controller to generate a variation in target FPS (Δtarget FPS) value, adding the variation in target FPS (Δtarget FPS) value and a current target FPS value to generate an updated target FPS value as an input to an FPS controller that generates a current FPS as an output, and adjusting the power based on the current FPS output by the FPS controller.

Some aspects may further include applying the updated target FPS and the current FPS value to the PID controller to generate a frequency adjustment value and adjusting a processing frequency based on the frequency adjustment value.

Some aspects may further include determining an updated current FPS value, determining whether the updated current FPS value is within a threshold range of the target FPS value, and repeating operations of applying the target FPS value and the current FPS value to the PID controller to generate the frequency adjustment value, adjusting the processing frequency based on the frequency adjustment value, determining the updated current FPS value, and determining whether the updated current FPS value is within the threshold range of the target FPS value until the current FPS value is within the threshold range of the target FPS value.

In some aspects, adjusting the processing frequency based on the frequency adjustment value may include setting maximum and minimum frequency values of a processing cluster.

In some aspects, applying the target FPS value and the current FPS value to the PID controller to generate the frequency adjustment value may include determining an error value based on a difference between the current FPS value and the target FPS value, applying the error value to a proportional term, integral term, and derivative term to obtain an output control variable, and determining the frequency adjustment value of each processing unit based on the output control variable and a load ratio of each processing unit.

Some aspects may further include determining an updated frequency adjustment value based on an output control variable, a frequency value of each processing unit, and a load ratio of each processing unit, and adjusting the processing frequency based on the updated frequency adjustment value.

Some aspects may further include repeatedly performing operations of determining updated frequency adjustment value based on the output control variable, the frequency value of each processing unit, and the load ratio of each processing unit, and adjusting the processing frequency based on the updated frequency adjustment value until the current FPS value is within a threshold range of the target FPS value.

Further aspects may include a computing device having a processor configured with processor-executable instructions to perform various operations corresponding to any of the methods described above.

Further aspects may include a non-transitory processor-readable storage medium having stored thereon processor-executable instructions configured to cause a processor to perform various operations corresponding to any of the methods described above.

Further aspects may include a computing device having various means for performing functions corresponding to any of the methods described above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIGS. 1-3 are component block diagrams illustrating computing systems that could be configured to implement some embodiments.

FIG. 4 is a process flow diagram illustrating an example Proportional-Integral-Derivative (PID) method in accordance with some embodiments.

FIG. 5 is a component block diagram illustrating a computing subsystem that includes a PID controller in accordance with some embodiments.

FIG. 6 is a component block diagram illustrating a computing subsystem that includes an enhanced PID controller that includes a frames per second (FPS) adjustment component that could be configured to stabilize FPS in accordance with some embodiments.

FIGS. 7-12 are process flow diagrams that illustrate methods of stabilizing FPS in accordance with some embodiments.

FIG. 13 is a component block diagram illustrating an example computing device suitable for use with various embodiments.

FIG. 14 is a component block diagram illustrating an example wireless communication device suitable for use with various embodiments.

FIG. 15 illustrates an example wearable computing device in the form of smart glasses suitable for use with various embodiments.

FIGS. 16A and 16B are component block diagrams illustrating a computing subsystem that includes an enhanced PID controller and FPS controller that could be configured to control power in accordance with some embodiments.

FIGS. 17-20 are process flow diagrams illustrating methods of controlling power in a computing device based on FPS displayed on the computing device according to some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

In overview, various embodiments include methods, and computing devices configured to implement the methods, for stabilizing frames per second (FPS) of video games or other animated applications operating on a computing device. The computing device may be configured to determine a target FPS, determine a current FPS, and use a Proportional-Integral-Derivative (PID) algorithm to determine a frequency adjustment value based on the target FPS and current FPS. The computing device may use the frequency adjustment value to dynamically change the clock frequency or processing frequency of one or more of the processors or resources in the device based on their current workloads and power consumption characteristics. The computing device may dynamically scale the processor frequencies based on the difference between the target FPS and the current FPS so that the current FPS comes within a target range without having a significant negative impact on the power consumption characteristics of the computing device.

In some embodiments, the computing device may be configured to determine an error value based on the difference between the target FPS and current FPS values, send the error value through a proportional term/gain, integral term/gain and derivative term/gain of the PID controller to obtain an output control variable, and determine the frequency adjustment value based on the output control variable. The computing device may use the frequency adjustment value to adjust the maximum and minimum clock frequencies of the processing units (e.g., CPU clusters, etc.) in the computing device. Said another way, the computing device may distribute the frequency adjustment value based on a load ratio to the various computing device subsystems (e.g., clusters, etc.).

Distributing the frequency adjustment value based on a load ratio and/or adjusting the maximum and minimum clock frequencies of the processing units in accordance with the various embodiments may improve the performance and functionality of the device by stabilizing FPS and balancing tradeoffs between performance and power consumption. Other improvements to the performance and functioning of the computing device will be evident from the disclosures herein.

The term “computing device” may be used herein to refer to any one or all of quantum computing devices, edge devices, Internet access gateways, modems, routers, network switches, residential gateways, access points, integrated access devices (IAD), mobile convergence products, networking adapters, multiplexers, personal computers, laptop computers, tablet computers, user equipment (UE), smartphones, personal or mobile multi-media players, personal data assistants (PDAs), palm-top computers, wireless electronic mail receivers, multimedia Internet enabled cellular telephones, gaming systems (e.g., PlayStation™, Xbox™, Nintendo Switch™, etc.), wearable devices (e.g., smart glasses, head-mounted display, fitness tracker, etc.), media players (e.g., DVD players, ROKU™, AppleTV™, etc.), digital video recorders (DVRs), automotive displays, portable projectors, 3D holographic displays, and other similar devices that include a display and a programmable processor that can be configured to provide the functionality of various embodiments.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC also may include any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.).

For example, an SoC may include an applications processor that operates as the SoC's main processor, central processing unit (CPU), microprocessor unit (MPU), arithmetic logic unit (ALU), etc. SoCs also may include software for controlling integrated resources and processors, as well as for controlling peripheral devices.

The term “system in a package” (SIP) may be used herein to refer to a single module or package that contains multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The term “frames per second” (FPS) may be used herein to refer to the number of images (frames) that are displayed on an electronic screen of a computing device per second. FPS is an important characteristic of some software applications, such as gaming applications. For example, a stable FPS may improve the overall gaming experience for many popular mobile games (e.g., Genshin, etc.). Such applications may require heavy workloads, which may lead to thermal problems and an unstable FPS. To ensure a smooth and enjoyable gaming experience, computing devices configured in accordance with the various embodiments may automatically adapt to the current workload and prevent thermal issues from arising.

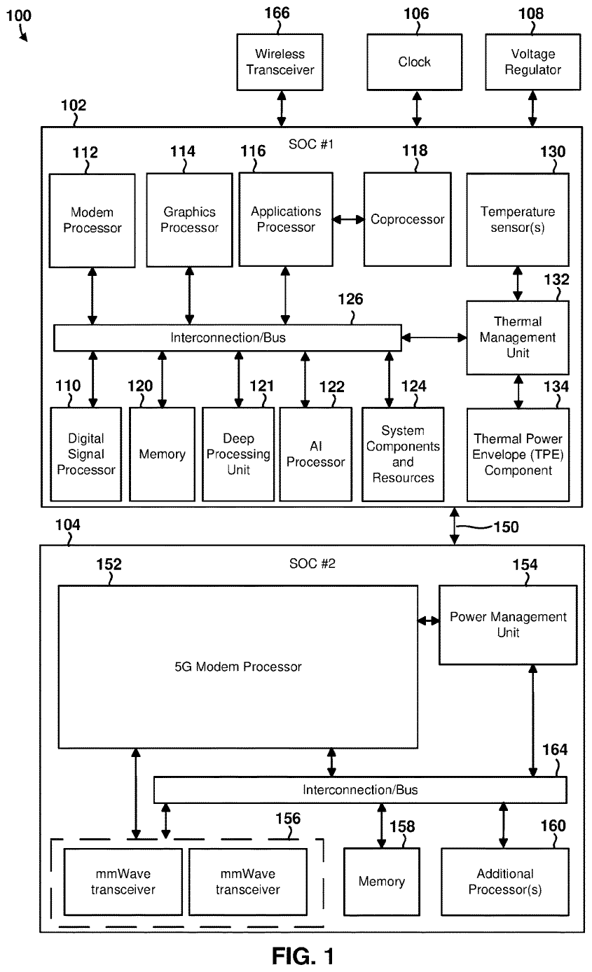

Various embodiments may be implemented on a number of single-processor and multiprocessor computer systems, including a system-on-chip (SOC) or system in a package (SIP). FIG. 1 illustrates an example computing system or SIP 100 architecture that may be used in mobile computing devices implementing various embodiments.

The example SIP 100 illustrated in FIG. 1 includes two SOCs 102, 104, a clock 106, a voltage regulator 108, and a wireless transceiver 166. The first and second SOC 102, 104 may communicate via interconnection/bus module 150. The various processors 110, 112, 114, 116, 118, 121, 122, may be interconnected to each other and to one or more memory elements 120, system components and resources 124 and a thermal management unit 132 via an interconnection/bus module 126.

Similarly, the processor 152 may be interconnected to the power management unit 154, the mm Wave transceivers 156, memory 158, and various additional processors 160 via the interconnection/bus module 164. The interconnection/bus module 126, 150, 164 may include an array of reconfigurable logic gates and/or implement a bus architecture (e.g., CoreConnect, AMBA, etc.). Communications may be provided by advanced interconnects, such as high-performance networks-on-chip (NoCs).

In some embodiments, the first SOC 102 may operate as the central processing unit (CPU) of the mobile computing device that carries out the instructions of software application programs by performing the arithmetic, logical, control and input/output (I/O) operations specified by the instructions. In some embodiments, the second SOC 104 may operate as a specialized processing unit. For example, the second SOC 104 may operate as a specialized 5G processing unit responsible for managing high volume, high speed (e.g., 5 Gbps, etc.), and/or very high-frequency short wavelength (e.g., 28 GHz mmWave spectrum, etc.) communications.

The first SOC 102 may include a digital signal processor (DSP) 110, a modem processor 112, a graphics processor 114, an application processor 116, one or more coprocessors 118 (e.g., vector co-processor) connected to one or more of the processors, memory 120, deep processing unit (DPU) 121, artificial intelligence processor 122, system components and resources 124, an interconnection/bus module 126, one or more temperature sensors 130, a thermal management unit 132, and a thermal power envelope (TPE) component 134. The second SOC 104 may include a 5G modem processor 152, a power management unit 154, an interconnection/bus module 164, a plurality of mmWave transceivers 156, memory 158, and various additional processors 160, such as an applications processor, packet processor, etc.

Each processor 110, 112, 114, 116, 118, 121, 122, 121, 122, 152, 160 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 10). In addition, any or all of the processors 110, 112, 114, 116, 118, 121, 122, 121, 122, 152, 160 may be included as part of a processor cluster architecture (e.g., a synchronous processor cluster architecture, an asynchronous or heterogeneous processor cluster architecture, etc.).

Any or all of the processors 110, 112, 114, 116, 118, 121, 122, 121, 122, 152, 160 may operate as the CPU of the mobile computing device. In addition, any or all of the processors 110, 112, 114, 116, 118, 121, 122, 121, 122, 152, 160 may be included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node's computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

In the various embodiments, any or all of the processors 110, 112, 114, 116, 118, 121, 122, 121, 122, 152, 160 may be configured to stabilize frames per second (FPS) by repeatedly applying a target FPS value and a current FPS value to an enhanced PID controller to generate frequency adjustment values, and using the frequency adjustment values to adjust or scale the processing frequencies in the SIP 100 until the current FPS value is within the threshold range of the target FPS value. Adjusting processing frequencies may include setting maximum and minimum frequency values of any or all of the processors, nodes or clusters discussed in this application.

The first and second SOC 102, 104 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC 102 may include power amplifiers, voltage regulators, oscillators, phase-locked loops, peripheral bridges, data controllers, memory controllers, system controllers, Access ports, timers, and other similar components used to support the processors and software clients running on a mobile computing device. The system components and resources 124 may also include circuitry to interface with peripheral devices, such as cameras, electronic displays, wireless communication devices, external memory chips, etc.

The first and/or second SOCs 102, 104 may further include an input/output module (not illustrated) for communicating with resources external to the SOC, such as a clock 106, a voltage regulator 108, and a wireless transceiver 166 (e.g., cellular wireless transceiver, Bluetooth transceiver, etc.). Resources external to the SOC (e.g., clock 106, voltage regulator 108, wireless transceiver 166) may be shared by two or more of the internal SOC processors/cores.

In addition to the example SIP 100 discussed above, various embodiments may be implemented in a wide variety of computing systems, which may include a single processor, multiple processors, multicore processors, or any combination thereof.

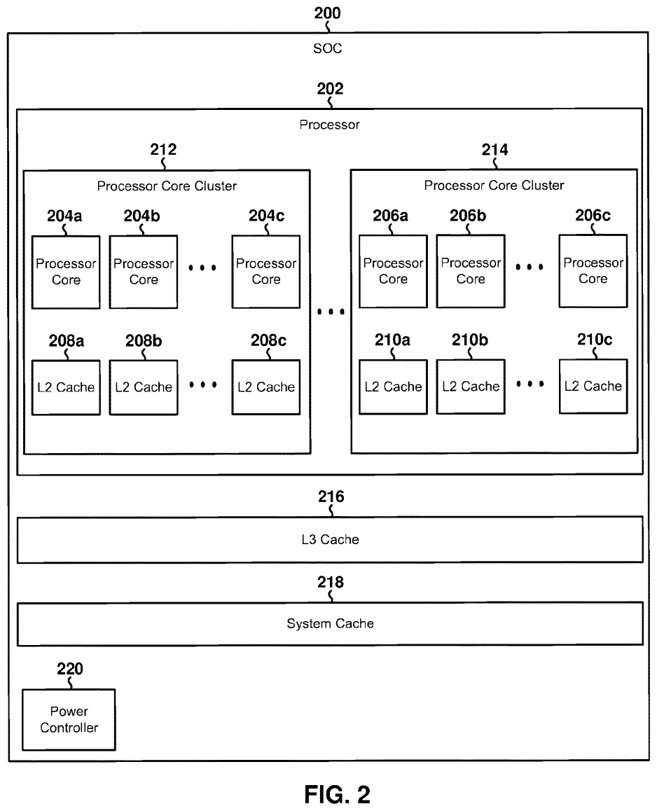

FIG. 2 illustrates an example SoC suitable for implementing various embodiments. With reference to FIGS. 1 and 2, an SoC 200 (e.g., SoC 102, 104 in FIG. 1), may include various combinations of components, including any number and combination of processors 202 (e.g., applications processor 116, graphics processor 114, etc.), an L3 cache 216 (e.g., memory 120, etc.), a system cache 218 (e.g., memory 120, etc.), and/or a power controller 220.

Each processor 202 in the SOC 200 may include any number and combination of processing cores 204a, 204b, 204c, 206a, 206b, 206c, any or all of which may be included as one or more nodes in one or more CPU clusters. In addition, processing cores 204a, 204b, 204c, 206a, 206b, 206c may be grouped together as processing core clusters 212, 214, any or all of which may be included as one or more nodes in one or more CPU clusters.

The processor 202 may include a plurality of homogeneous or heterogeneous processing cores 204a, 204b, 204c, 206a, 206b, 206c. A homogeneous multicore processor may include a plurality of homogeneous processing cores. The processing cores 204a, 204b, 204c, 206a, 206b, 206c may be homogeneous in that, the processing cores 204a, 204b, 204c, 206a, 206b, 206c of the multicore processor 202 may be configured for the same purpose and have the same or similar performance characteristics (e.g., maximum and minimum frequency values, etc.). For example, the multicore processor 202 may be a general-purpose processor, and the processing cores 204a, 204b, 204c, 206a, 206b, 206c may be homogeneous general-purpose processing cores. As another example, the multicore processor 202 may be a graphics processor 112 or a DSP 110, and the processing cores 204a, 204b, 204c, 206a, 206b, 206c may be homogeneous graphics processing cores or digital signal processing cores, respectively.

A heterogeneous multicore processor may include a plurality of heterogeneous processing cores. The processing cores 204a, 204b, 204c, 206a, 206b, 206c may be heterogeneous in that the processing cores 204a, 204b, 204c, 206a, 206b, 206c of the multicore processor 202 may be configured for different purposes and/or have different performance characteristics. The heterogeneity of such heterogeneous processing cores may include different instruction set architectures, pipelines, operating frequencies, etc. An example of such heterogeneous processing cores may include what is known as “big.LITTLE” architectures in which slower, low-power processing cores may be coupled with more powerful and power-hungry processing cores.

Generally, processing core clusters 212, 214 may include homogeneous processing cores within each processing core cluster 212, 214. Processing core clusters 212, 214 may be homogeneous or heterogeneous with other processing core clusters 212, 214. For example, processing core clusters 212 and 214 may be homogeneous having the same processing cores as each other. As another example, processing core clusters 212 and 214 may be heterogeneous having different processing cores from each other.

The processor 202 may further include any number and combination of L2 caches 208a, 208b, 208c, 210a, 210b, 210c (e.g., memory 120 in FIG. 1). For example, each processing core cluster 212, 214 and/or each processing core 204a, 204b, 204c, 206a, 206b, 206c may have a dedicated L2 cache 208a, 208b, 208c, 210a, 210b, 210c. Each L2 cache 208a, 208b, 208c, 210a, 210b, 210c may be designated for read and/or write access by a designated processing core cluster 212, 214 and/or processing core 204a, 204b, 204c, 206a, 206b, 206c. The L2 cache 208a, 208b, 208c, 210a, 210b, 210c may store data and/or instructions, and make the stored data and/or instructions available to the designated processing core cluster 212, 214 and/or processing core 204a, 204b, 204c, 206a, 206b, 206c. The L2 caches 208a, 208b, 208c, 210a, 210b, 210c may include volatile memory as described herein with reference to memory 120 of FIG. 1.

The L3 cache 216 and the system cache 218 may be shared by and configured for read and/or write access by the processing core clusters 212, 214 and/or the processing cores 204a, 204b, 204c, 206a, 206b, 206c. The L3 cache 216 and the system cache 218 may store data and/or instructions, and make the stored data and/or instructions available to the processing core clusters 212, 214 and/or the processing cores 204a, 204b, 204c, 206a, 206b, 206c. The L3 cache 216 and/or the system cache 218 may function as a buffer for data and/or instructions input to and/or output from the processor 202. The L3 cache 216 and the system cache 218 may include volatile memory as described herein with reference to memory 120 of FIG. 1.

The processor 202 may further include any number and combination of power controllers 220, such as one or more power management integrated circuits (PMIC). A power controller 220 may be configured to control an amount of power provided to any number and combination of the processing core clusters 212, 214 and/or the processing cores 204a, 204b, 204c, 206a, 206b, 206c. The power provided to a processing core cluster 212, 214 and/or a processing core 204a, 204b, 204c, 206a, 206b, 206c, as controlled by the power controller 220, may be determined by a state of the processing core cluster 212, 214 and/or the processing core 204a, 204b, 204c, 206a, 206b, 206c.

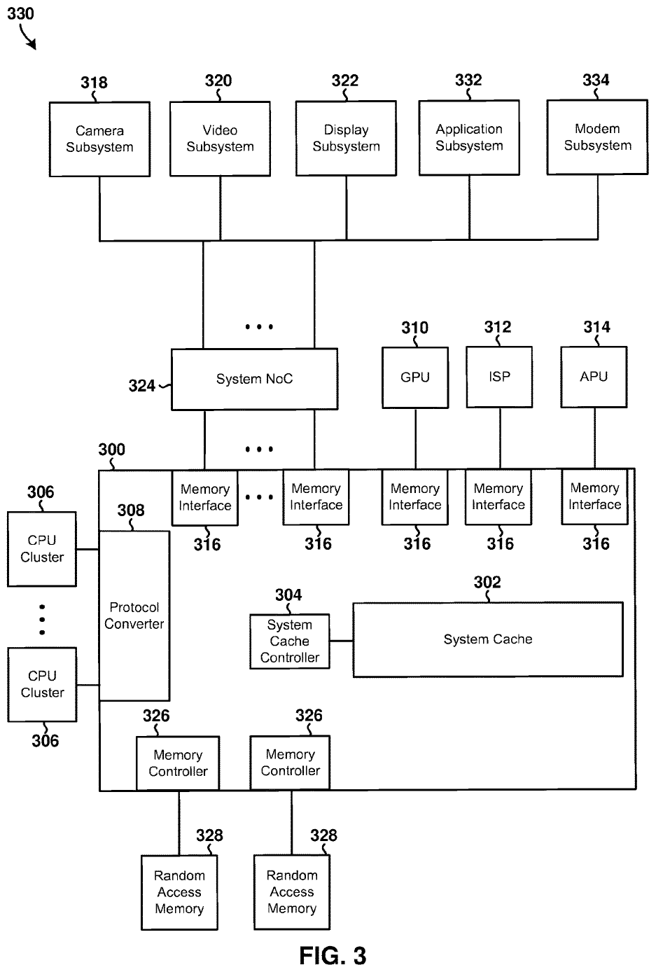

FIG. 3 illustrates another example SoC suitable for implementing various embodiments. With reference to FIGS. 1-3, an SoC 330 and/or a CPU cluster 306 may include a variety of components as described above (e.g., processors 110, 112, 114, 116, 118, 121, 122, 121, 122, 152, 160, 202, processing cores 204a, 204b, 204c, 206a, 206b, 206c, etc.). Some of such components and additional components may be subsystems of the computing device. The SoC 330 may include various communication components configured to communicatively connect the components of the SoC 330 that may transmit, receive, and share data. The communication components may include a system hub 300, a protocol converter 308, and a system network on chip (NoC) 324. The communication components may facilitate communication between subsystem components, such as processors in CPU clusters 306 and various other subsystems, such as the camera subsystem 318, video subsystem 320, display subsystem 322, application subsystem 332, modem subsystem 334 and specialized processors, such as a graphics processor unit (GPU) 310, an image signal processor (ISP) 312, an accelerated processing unit (APU) 314, and other hardware accelerators.

The ISP 312 may be a specialized digital signal processor designed for processing image data and producing high-quality images. The APU 314 may be a single integrated chip that combines the functions of a CPU and GPU on one die to increase performance and power efficiency. In some embodiments, any or all of the GPU 310, modem ISP 312 and APU 314 may be included in one or more CPU clusters 306.

The communication components may facilitate communication between the subsystems 318, 320, 322, 332, 334 and the processing units 306, 310, 312, 314 with other components such as memory devices, including a system cache 302, a random access memory (RAM) 328, and various memories included in the CPU clusters 306, such as caches of the processors of the CPU cluster 306.

Various memory control devices, such as a system cache controller 304, a memory interface 316, and a memory controller 326, may be configured to control access to the various memories (e.g., RAM 328) by the subsystems 318, 320, 322, 332, 334 and the processors 306, 310, 312, 314 and implement operations for the various memories, which may be requested by the subsystems 318, 320, 322, 332, 334 and the processors 306, 310, 312, 314.

The SoC 330 may be configured to repeatedly apply a target FPS value and a current FPS value to a PID controller to generate frequency adjustment values, and use the frequency adjustment values to adjust or scale processing frequencies of any of the processing units discussed in this application (e.g., processors 110, 112, 114, 116, 118, 121, 122, 121, 122, 152, 160, 306, 310, 312, 314, processing cores 204a, 204b, 204c, 206a, 206b, 206c, etc.) until the current FPS value is within the threshold range of the target FPS value.

The descriptions herein of the SoC 330 and its various components illustrated in FIG. 3 are only meant to be examples and in no way limiting. Several of the components of the illustrated example SoC 330 may be variably configured, combined, and separated. Several of the components may be included in greater or fewer numbers, and may be located and connected differently within the SoC 330 or separate from the SoC 330. Similarly, numerous other components, such as other memories, processors, subsystems, interfaces, and controllers, may be included in the SoC 330 and in communication with the system cache controller 304 in order to access the system cache 302.

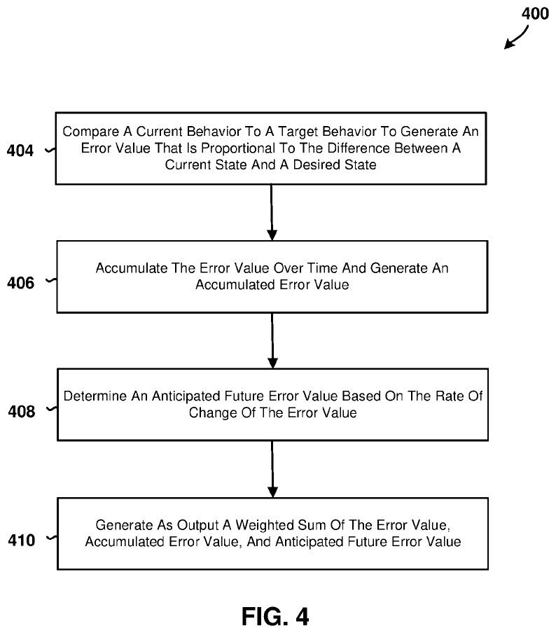

FIG. 4 illustrates a Proportional-Integral-Derivative (PID) method 400 that may be used in some embodiments. With reference to FIGS. 1-4, the method 400 may be performed in a computing device by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, and/or components (e.g., PID controller 504, FPS adjustment component 602, etc.) discussed in this application. Means for performing the functions method 400 may include any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, and/or components (e.g., PID controller 504, FPS adjustment component 602, etc.) discussed in this application.

In block 402, the computing device may compare the system's current behavior to the target behavior to generate an output that is proportional to the difference between the current state and the target state. The difference between the current state and the target state may be referred to as the “error.” A proportionality constant, also known as the gain or gain factor “Kₚ”, may be used to control how much the output will change for a given error.

In block 404, the computing device may accumulate the error value over time and generate an output that is proportional to the accumulated error value. The computing device may reduce residual errors by accounting for the accumulated past error.

In block 406, the computing device may anticipate a future error value based on the rate of change of the error value and generate an output that is proportional to the rate of change of the error. The computing device may reduce overshooting and oscillations by accounting for the rate of change of the error.

In block 408, the computing device may generate as output a weighted sum of the error value, accumulated error value, and anticipated further error value.

In some embodiments, the computing device may be equipped with an enhanced PID controller suitable for performing frequency control operations (e.g., adjusting the maximum and minimum clock frequencies of the processors) to stabilize the FPS. An important advantage of using a PID controller for frequency control is that it provides a closed-loop control system. In contrast to open-loop control systems, which simply adjust the frequency without considering the current FPS state, the enhanced PID controller considers the current FPS during frequency adjustments. This may allow for a more precise and responsive control system that maintains FPS stability and reduces power consumption.

Some embodiments may use the PID controller to introduce negative feedback into the system by repeatedly or continuously monitoring the current FPS state and adjusting the clock frequencies of the processors based on the current FPS state. If the FPS is too low, the clock frequency may be increased to improve performance. If the FPS is too high, the clock frequency may be decreased to reduce power consumption. As such, the embodiments may quickly and reliably return the FPS to the target FPS, maintain FPS stability, and improve the performance and power consumption characteristics of the computing device.

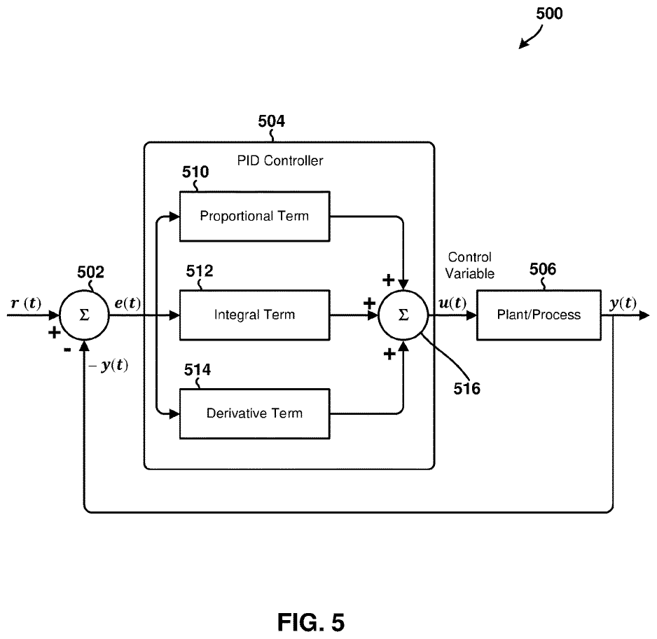

FIG. 5 illustrates a computing subsystem 500 that includes a Proportional-Integral-Derivative (PID) controller that could be configured to implement a frequency control in accordance with some embodiments. With reference to FIGS. 1-5, the computing subsystem 500 may be included in a computing device and implemented by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.) discussed in this application.

The computing subsystem 500 may include a summation component 502, a PID controller 504, and a plant/process component 506. The PID controller 504 may include a proportional term component 510, an integral term component 512, a derivative term component 514, and a PID controller output component 516.

The summation component 502 may be configured to add or sum a setpoint (( )) and an inverse of the feedback of a process variable (( )) output from the plant/process component 506 to generate an error value (( )=( )−( )) as input for the PID controller 504. In some embodiments, the setpoint ( ) may be the target FPS and the process variable ( ) may be the current FPS.

The proportional term component 510 may be configured to compare the current FPS to the target FPS to generate an output that is proportional to the difference between the current FPS value and the target FPS value. The difference between the current FPS value and the target FPS value may be referred to as the error ( ). In some embodiments, a proportionality constant (also known as the gain) may be used to control how much the output will change for a given error.

The integral term component 512 may be configured to accumulate the error (difference between the target FPS and the current FPS) over time. The integral term component 512 may reduce residual errors by accounting for the accumulated past error. The integral term component 512 may generate an output that is proportional to the accumulated error over time.

The derivative term component 514 may be configured to anticipate a future error value based on the rate of change of the error. The derivative term component 514 may reduce overshooting and oscillations by accounting for the rate of change of the error. The derivative term component 514 may generate an output that is proportional to the rate of change of the error.

The PID controller output component 516 may be configured to generate a weighted sum of the outputs generated by the proportional term component 510, the integral term component 512, and the derivative term component 514 to generate a control variable ( ). In some embodiments, the control variable ( ) may be a frequency variation value (Δfreq).

The plant/process component 506 may be configured to generate a process variable (PV)=( ):( )=( )−( ) based on the control variable ( ), which may be fed back as input to the PID controller 504. As such, the computing subsystem 500 may operate as a control loop mechanism that utilizes feedback to continuously adjust and control processor clock frequencies and the current FPS. The computing subsystem 500 may continuously or repeatedly calculate an error value ( ) as the difference between a target setpoint=( ) and a measured process variable=( ):( )=( )−( ), and apply a correction based on proportional, integral, and derivative terms. The computing subsystem 500 may minimize the error over time by adjusting the control variable ( ) to a new value determined by a weighted sum of the outputs of the proportional, integral, and derivative terms.

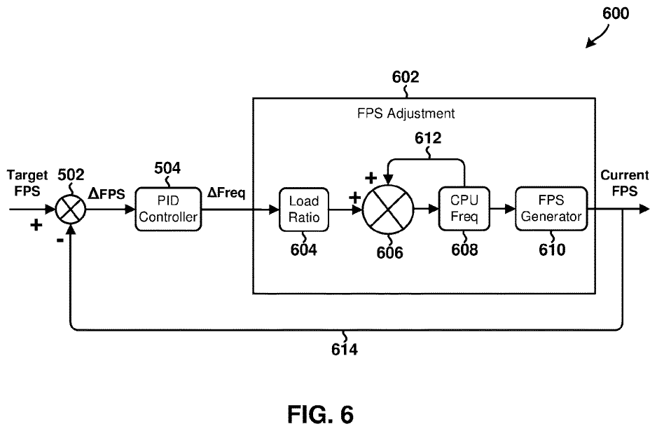

FIG. 6 illustrates a computing subsystem 600 that includes an enhanced PID controller that includes an FPS adjustment component that could be configured to implement a frequency control in accordance with some embodiments. With reference to FIGS. 1-6, the computing subsystem 600 may be included in a computing device and implemented by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.) discussed in this application.

The system 600 may include a summation component 502, a PID controller 504, and an FPS adjustment component 602. The FPS adjustment component may include a load ratio component 604, FPS adjustment summation component 606, a CPU frequency component 608, and an FPS generator component 610. The setpoint ( ) may be the target FPS, the process variable ( ) may be the current FPS, the error value ( ) may be the difference between the target FPS and current FPS (Δfps), and the output control variable ( ) may be the frequency variation (Δfreq).

The computing subsystem 600 may receive a target FPS value as input and generate a current FPS value as output. The target FPS value may represent the FPS required under the current application conditions or configuration. The current FPS value may represent the actual measured FPS of the application. The computing subsystem 600 may adjust the frequency of a processing unit associated with an application (e.g., game, video, animation, etc.) based on the differences between the target FPS and the current FPS (Δfps).

The summation component 502 may receive the target FPS and current FPS values as inputs and generate an error signal value (( )) based on the difference between the target FPS and current FPS values (Δfps) as output. The PID controller 504 may receive the error signal value (( )=Δfps) as input and generate an output control variable (( )) based on the frequency variation (Δfreq).

The load ratio component 604 may be configured to determine the load ratio value (or current workload value) based on the current workloads and capabilities of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.) in the computing system or associated with the application. In some embodiments, the load ratio component 604 may determine the load ratio value based on a CPU utilization and capacity ratio map information structure, a normalized capacity ratio map information structure, and/or a frequency-to-capacity ratio normalization map information structure.

The load ratio component 604 may receive the output control variable (( )=Δfreq) as input, and generate output based on the output control variable and the load ratio value. The load ratio component 604 may also send the output control variable (( )=Δfreq) to the processors/clusters. As such, each processing unit may have a new updated frequency value (e.g., updated_freq[cluster_id]=Δfreq[cluster_id]+current_freq[cluster_id]).

The FPS adjustment summation component 606 may sum the output of the load ratio component 604 and a performance value (e.g., frequency adjustment value, etc.) that is determined based on the output control variable (( )). The FPS adjustment summation component 606 may output the summation result as an updated frequency value to the CPUFreq component 608.

The CPUFreq component 608 may be included in the kernel and configured to adjust the frequency of the processing units based on the updated frequency values received from the FPS adjustment summation component 606. In some embodiments, the CPUFreq component 608 may be configured to adjust the frequency of each processing cluster or CPU cluster, instead of each individual processor. For example, the CPUFreq component 608 may update the frequency of a processing core cluster 212, 214 or CPU cluster 306 by setting maximum and minimum values of updated_freq[cluster_id]. This may be particularly beneficial in homogeneous processing core clusters or in systems in which groups of processors or CPUs share the same attributes (e.g., frequency points).

As mentioned above, the CPUFreq component 608 may be configured to adjust the frequency of the processing units. Such changes in frequency may impact the future or current FPS generation. As such, the CPUFreq component 608 may provide feedback 612 to the FPS adjustment summation component 606. The FPS adjustment summation component 606 may use the feedback 612 to repeatedly or continuously generate new updated frequency values that are sent to the CPUFreq component 608. The CPUFreq component 608 may provide a performance value (frequency adjustment value) to the FPS generator component 610.

The FPS generator component 610 may receive as input the performance value from the CPUFreq component 608. The FPS generator component 610 may adjust the current FPS based on the received performance value.

The computing subsystem 600 may utilize negative feedback 614 to stabilize the FPS and return it to the target FPS value quickly and smoothly in the event of a “jank” or a temporary glitch or stutter in the smoothness of a video or animation, which would otherwise negatively impact the user experience. A jank may occur when the frame rate of an application drops below its target value, resulting in a noticeable interruption in the fluidity of motion. A jank may be caused by various factors or conditions, such as insufficient processing power or excessive load on the system.

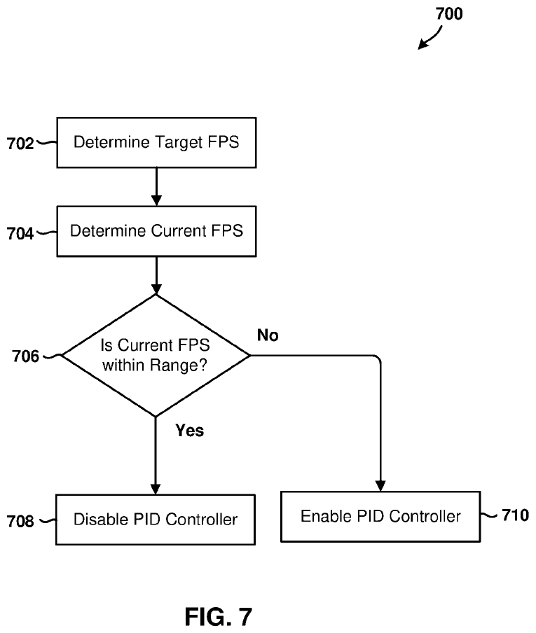

FIG. 7 illustrates a method 700 of adjusting the frame rate in a computing device in accordance with some embodiments. With reference to FIGS. 1-7, the method 700 may be performed in a computing device by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, and/or components (e.g., PID controller 504, FPS adjustment component 602, etc.) discussed in this application. Means for performing the functions method 700 may include any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, and/or components (e.g., PID controller 504, FPS adjustment component 602, etc.) discussed in this application.

In block 702 the computing device may determine a target FPS (e.g., 90 fps). The target FPS value may represent the FPS required under the current application conditions or configuration. The computing device may determine the target FPS based on any of a variety of factors, including application type, graphics quality, hardware specifications, and/or user preferences. Generally, a target frame rate of 30-60 frames per second (fps) is considered to be stable and provide a smooth application (gaming, etc.) experience. However, modern mobile games (e.g., Genshin, etc.) may require a much higher frame rate (e.g., 80-100 fps, etc.).

In block 704, the computing device may determine a current FPS. Generally, the number of individual images (frames) that are displayed per second, or the current FPS, may differ from the target FPS for a variety of reasons, including hardware performance, graphics settings, background processes, game or application design, and network lag. The computing device may determine the current FPS by measuring the time it takes to render each frame and/or measuring the number of frames that are actually displayed in one second.

In determination block 706, the computing device may determine whether the current FPS is within range (e.g., 89.4-92 fps) of the target FPS. For example, the computing device may determine whether the difference between the current FPS value and the target FPS value exceeds a threshold value (e.g., 0.5 fps, 1 fps, 2.6 fps, etc.). In some embodiments, the computing device may determine whether the current FPS is within range by comparing the current FPS to a minimum FPS value and/or a maximum FPS value for an application (e.g., a gaming application, etc.).

In response to determining that the current FPS is within range (i.e., determination block 706=“Yes”), the computing device may disable the PID controller in block 708. For example, in some embodiments, the computing device may disable the PID controller 504 and the FPS adjustment component 602 in response to determining that the difference between the current FPS value and the target FPS value does not exceed a threshold value (or is within the target range, etc.).

In response to determining that the current FPS value is not within range (i.e., determination block 706=“No”), the computing device may enable the PID controller in block 710. For example, in some embodiments, the computing device may enable the PID controller 504 and the FPS adjustment component 602 in response to determining that the difference between the current FPS value and the target FPS value exceeds a threshold value.

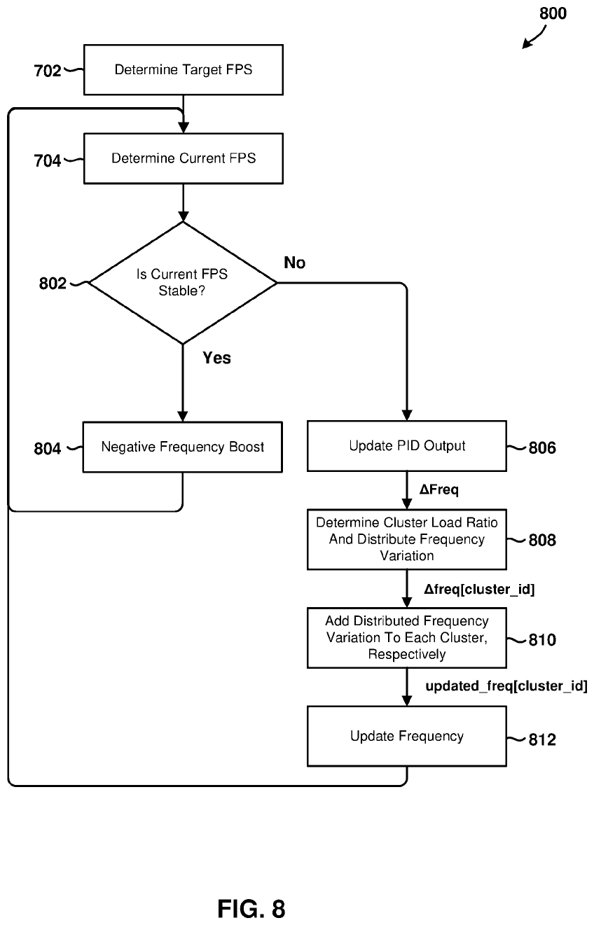

FIG. 8 illustrates a method 800 of adjusting FPS in a computing device in accordance with some embodiments. With reference to FIGS. 1-8, the method 800 may be performed in a computing device by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, and/or components (e.g., PID controller 504, FPS adjustment component 602, etc.) discussed in this application. Means for performing the functions method 800 may include any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, and/or components (e.g., PID controller 504, FPS adjustment component 602, etc.) discussed in this application.

In blocks 702 and 704, the computing device may perform the operations of the like numbered blocks of the method 700 as described. For example, the computing device may determine a target FPS in block 702 and a current FPS in block 704. In determination block 802, the computing device may determine whether the current FPS is stable. In some embodiments, the computing device may determine that the current FPS is a stable FPS by determining whether the current FPS is within range of the target FPS or by determining whether the difference between the current FPS value and the target FPS value exceeds a threshold value. In some embodiments, the computing device may compute a standard deviation value that measures how much the current FPS varies from the average FPS over a period of time. In some embodiments, the computing device may determine whether the current FPS is stable based on a standard deviation value. For example, a low standard deviation value may indicate that the FPS is consistent and stable, and a high standard deviation value may indicate that the FPS is fluctuating and not stable. In some embodiments, the computing device may determine whether the current FPS is stable based on a combination of the standard deviation value and the threshold FPS.

In response to determining that the current FPS is stable (i.e., determination block 802=“Yes”), the computing device may perform a negative frequency boost operation in block 804. The negative frequency boost operation may include reducing the frequency of a processing unit to reduce heat generation and/or improve the energy consumption characteristics of the device.

In response to determining that the current FPS is not stable (i.e., determination block 802=“No”), the computing device may update the PID output in block 806. For example, the PID controller 504 of the computing device may generate an output control variable based on the frequency variation (Δfreq) or difference between the target FPS and the measured current FPS. As another example, the computing device may determine an error value based on a difference between a current FPS and a target FPS, apply the error value to a proportional term/gain, integral term/gain, and derivative term/gain to obtain an output control variable, determine a frequency adjustment value based on the output control variable, and use the frequency adjustment value to adjust or scale processing frequencies in the computing device to alter the current FPS.

In block 808, the computing device may determine a cluster load ratio and distribute a frequency variation value to the clusters. For example, the computing device may determine processing unit workloads and capabilities (or frequency-to-capacity ratio normalization map, etc.), and determine the cluster load ratio based on the current workloads and capabilities. As another example, the load ratio component 604 of the computing device may receive the output control variable as input, generate a load ratio value, and update the clock or operating frequencies of the processing units (e.g., CPU cluster 306, etc.) based on the load ratio value. The FPS adjustment summation component 606 of the computing device may sum the load ratio value and a performance value (e.g., frequency adjustment value) to generate an updated frequency value.

In block 810, the computing device may add the distributed frequency variation to each processing unit in one or more clusters. For example, the CPUFreq component 608 of the computing device may send an updated frequency value to one or more of the CPU clusters 306, each of which may use the distributed frequency variation to adjust the operating frequencies of any or all of its corresponding processing units (e.g., any or all of processors 110, 112, 114, 116, 118, 121, 122, 121, 122, 152, 160, 306, 310, 312, 314, processing cores 204a, 204b, 204c, 206a, 206b, 206c, etc.).

In block 812, the computing device may update the frequency in the processors/clusters. For example, the CPUFreq component 608 may set new minimum and maximum processing unit frequency values on the CPU cluster 306 to adjust the frequency of the processing units based on the updated frequency values. The computing device may continuously or repeatedly perform the operations in blocks 704-812 to maintain a stable FPS.

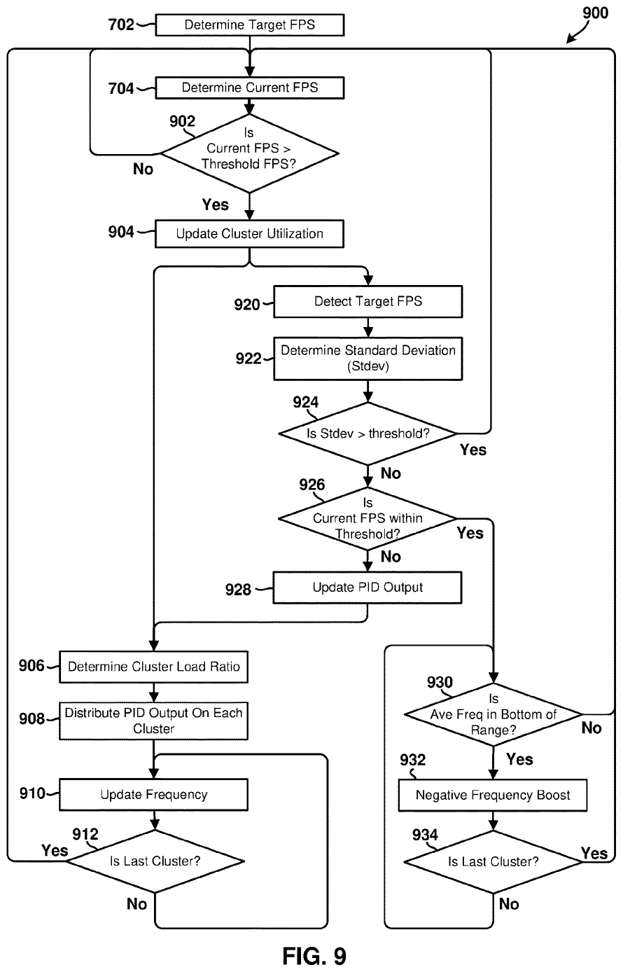

FIG. 9 illustrates a method 900 of adjusting FPS in a computing device in accordance with some embodiments. With reference to FIGS. 1-9, the method 900 may be performed in a computing device by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504, FPS adjustment component 602, etc.) discussed in this application. Means for performing the functions method 900 may include any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504, FPS adjustment component 602, etc.) discussed in this application. While some of the examples below are discussed with reference to a cluster (e.g., CPU cluster, etc.), it should be understood that the operations may be performed on any processing unit, subsystem or component discussed in this application.

In blocks 702 and 704, the computing device may perform the operations of the like-numbered blocks of method 700 as described. For example, the computing device may determine a target FPS in block 702 and a current FPS in block 704. In determination block 902, the computing device may determine whether the current FPS is greater than the threshold FPS. For example, the computing device may invoke a compare function or determine whether the difference between the current FPS value and the threshold FPS is zero, a value greater than zero, etc.

In response to determining that the current FPS is not greater than the threshold FPS (i.e., determination block 902=“No”), the computing device may determine the current FPS in block 704. For example, when a gaming application is loading, the FPS is generally very low but should not trigger the frequency controls. As such, if the current FPS is not greater than the threshold FPS in determination block 902, the system does not trigger the frequency controls. Rather, the computing device waits until after the current FPS surpasses the threshold FPS before commencing to enforce the frequency controls.

In response to determining that the current FPS is greater than the threshold FPS (i.e., determination block 902=“Yes”), the computing device may update the cluster utilization in block 904. For example, the computing device may monitor and collect information regarding the current usage of resources in a CPU cluster (e.g., CPU utilization, memory utilization, network utilization, etc.), cluster performance, workloads, capabilities, resource allocations, and perform other operations to ensure that the cluster is running efficiently and/or to avoid overloading or underutilizing any of its components. In some embodiments, as part of the operations in block 902, the computing device may generate a CPU utilization and capacity ratio map, a normalized capacity ratio map, and/or a frequency-to-capacity ratio normalization map.

In some embodiments, the computing device may perform the operations in blocks 906-912 in parallel with any or all of the other operations (e.g., in blocks 920-934). In block 906, the computing device may determine the cluster load ratio. For example, the load ratio component 604 may determine the cluster load ratio (e.g., a load ratio value, etc.) based on the current workloads and capabilities of the processors/clusters in the computing system. As another example, the load ratio component 604 may determine the cluster load ratio based on a CPU utilization and capacity ratio map, a normalized capacity ratio map, and/or a frequency-to-capacity ratio normalization map.

In block 908, the computing device may send or distribute the PID output to each processing unit. For example, in block 908, the computing device may distribute the frequency adjustment value based on the load ratio to the various processing units (e.g., CPU cluster 306, etc.). By distributing the frequency adjustment value based on the load ratio, the computing device may allow the processing units to adjust the maximum and minimum processing frequencies to stabilize FPS and balance tradeoffs between performance and power consumption.

In block 910, the computing device may update the frequency of the associated processing units. For example, the computing device may adjust the maximum and minimum processing frequencies of the processing units in each CPU cluster 306 to stabilize FPS and balance tradeoffs between performance and power consumption.

In determination block 912, the computing device may determine whether the current processing unit is the last cluster to be evaluated or updated. For example, the system may include multiple CPU clusters 306 and the operations of method 900 may be performed for each CPU cluster 306.

In response to determining that the current cluster is the last cluster to be evaluated or updated (i.e., determination block 912=“Yes”), the computing device may determine the current FPS in block 704. The current FPS is the current frame rate for an application operating on the computing device. The computing device may determine the current FPS by measuring the number of frames rendered in a specific interval of time (e.g., 1 second).

In response to determining that the current cluster is not the last cluster to be evaluated or updated (i.e., determination block 912=“No”), the computing device may update the frequency in the next cluster in block 910. The computing device may perform the operations in blocks 910 and 912 until all the clusters or processing units in the system that are associated with an application have been updated.

In block 920, the computing device may detect the target FPS. The target FPS value may represent the FPS required under the current application conditions or configuration. The computing device may determine the target FPS based on any of a variety of factors, including application type, graphics quality, hardware specifications, and/or user preferences.

In block 922, the computing device may determine a standard deviation value. For example, the computing device may compute a standard deviation value that measures how much the current FPS varies from the average FPS over a period of time. The computing device may calculate the standard deviation value by computing the difference between the current FPS value and the average FPS value over a period of time and finding the square root of the sum of these differences squared, divided by the number of data points to generate a value that represents the deviation from the average FPS value and indicates the degree of variation in the FPS readings.

In determination block 924, the computing device may determine whether the standard deviation value is greater than a threshold value. In some embodiments, the computing device may determine whether the current FPS value is stable based on whether the standard deviation value is greater than a threshold value. In some embodiments, the computing device may determine that the current FPS value is stable in by determining whether the current FPS value is within range of the target FPS value or by determining whether the difference between the current FPS value and the target FPS value exceeds a threshold value. In some embodiments, the computing device may determine whether the current FPS value is stable based on a combination of the standard deviation value and the threshold FPS value.

In response to determining that the standard deviation value is greater than the threshold value (i.e., determination block 924=“Yes”), the computing device may determine the current FPS value in block 704. The computing device may determine the current FPS value by measuring the number of frames rendered in a specific interval of time (e.g., 1 second).

In response to determining that the standard deviation value is greater than the threshold value (i.e., determination block 924=“No”), the computing device may determine whether the current FPS is within a threshold range in determination block 926. For example, the computing device may compare the current FPS value to a predefined threshold range to determine whether the current FPS value falls within the range. The computing device may determine the threshold range based on various factors, such as hardware specifications, the target level of performance, or user preferences.

In response to determining that the current FPS value is not within the threshold range (i.e., determination block 926=“No”), the computing device may update the PID output in block 928, then proceed to perform the operations in blocks 906-912. For example, the computing device may determine an error value based on a difference between a current FPS value and a target FPS value, apply the error value to a proportional term/gain, integral term/gain, and derivative term/gain to obtain an output control variable, determine a frequency adjustment value based on the output control variable, and use the frequency adjustment value to adjust or scale processing frequencies in the computing device to alter the current FPS value.

In response to determining that the current FPS is within the threshold range (i.e., determination block 926=“Yes”), the computing device may determine whether the average frequency is within the bottom of the current frequency range in determination block 930. For example, the computing device may calculate the average frequency over a period of time and compare the average frequency to a predetermined value that identifies the bottom of the current frequency range.

In response to determining that the average frequency is not within the bottom of the current frequency range (i.e., determination block 930=“Yes”), the computing device may determine the current FPS value in block 704. The computing device may determine the current FPS value by measuring the number of frames rendered in a specific interval of time (e.g., 1 second).

In response to determining that the average frequency is within the bottom of the current frequency range (i.e., determination block 930=“Yes”), the computing device may perform a negative frequency boost in block 932. The negative frequency boost operation may reduce the frequency of a processing unit to reduce power consumption.

In determination block 934, the computing device may determine whether the current cluster is the last cluster to be evaluated or updated. For example, the system may include multiple CPU cluster 306 and the operations of method 900 may be performed for each CPU cluster 306.

In response to determining that the current cluster is the last cluster to be evaluated or updated (i.e., determination block 934=“Yes”), the computing device may determine the current FPS value in block 704. The computing device may determine the current FPS value by measuring the number of frames rendered in a specific interval of time (e.g., 1 second).

In response to determining that the current cluster is the last cluster to be evaluated or updated (i.e., determination block 934=“Yes”), the computing device may determine the current FPS value in block 704. The computing device may determine the current FPS value by measuring the number of frames rendered in a specific interval of time (e.g., 1 second).

In response to determining that the current cluster is not the last cluster to be evaluated or updated (i.e., determination block 934=“No”), the computing device may perform the operations in blocks 930-934 until all the clusters in the system that are in within the bottom of the current frequency range have received the negative frequency boost. A negative frequency boost operation may lower the operating frequency of a processing unit to conserve power.

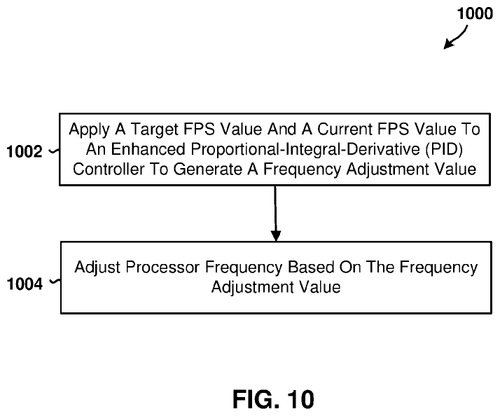

FIG. 10 illustrates a method 1000 of stabilizing FPS displayed on a computing device in accordance with some embodiments. With reference to FIGS. 1-10, the method 1000 may be performed in a computing device by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504, FPS adjustment component 602, etc.) discussed in this application. Means for performing the functions method 1000 may include any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504, FPS adjustment component 602, etc.) discussed in this application.

In block 1002, the computing device may apply a target FPS value and a current FPS value to a PID controller to generate a frequency adjustment value. In some embodiments, the computing device may generate the frequency adjustment value by determining an error value based on a difference between the current FPS value and the target FPS value, applying the error value to a proportional term component 51, integral term component 512, and derivative term component 514 to obtain an output control variable, and determining the frequency adjustment value based on the output control variable. In some embodiments, the computing device may be configured to generate the output control variable based on a weighted sum of the outputs generated by the proportional term component 510, the integral term component 512, and the derivative term component 514. In some embodiments, the output control variable may be a frequency variation value (Δfreq).

In block 1004, the computing device may adjust a processing frequency based on the frequency adjustment value. In some embodiments, the computing device may determine the frequency adjustment value of each CPU cluster (e.g., CPU clusters 306, etc.) based on the output control variable and a load ratio of each corresponding CPU cluster. In some embodiments, the computing device may adjust the processing frequency based on the frequency adjustment value by setting maximum and minimum frequency values of a processing unit (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.).

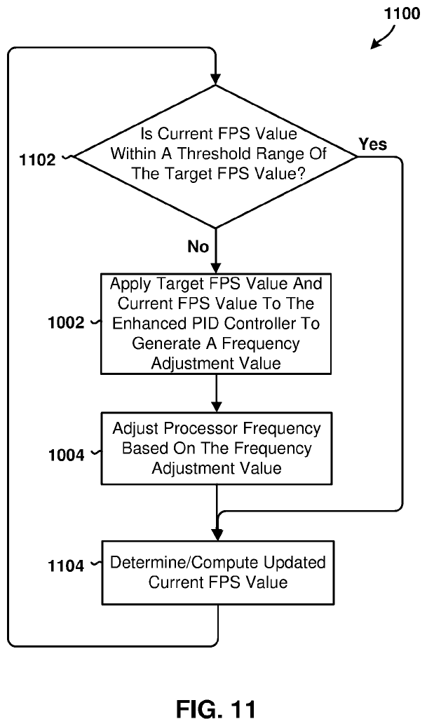

FIG. 11 illustrates a method 1100 of stabilizing FPS displayed on a computing device in accordance with some embodiments. With reference to FIGS. 1-11, the method 1100 may be performed in a computing device by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504, FPS adjustment component 602, etc.) discussed in this application. Means for performing the functions method 1100 may include any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504, FPS adjustment component 602, etc.) discussed in this application.

In determination block 1102, the computing device may determine whether the current FPS value is within a threshold range of the target FPS value. For example, the computing device may compare the current FPS to a predefined threshold range value to determine whether the current FPS falls within the range. The computing device may determine the threshold range based on various factors, such as hardware specifications, the target level of performance, or user preferences.

In response to determining that the current FPS is not within the threshold range (i.e., determination block 1102=“No”) in blocks 1002 and 1004 the computing device may perform the operations of the like numbered blocks of the method 1000 as described. For example, the computing device may determine an error value based on a difference between a current FPS and a target FPS, apply the error value to a proportional term/gain, integral term/gain, and derivative term/gain to obtain an output control variable, determine a frequency adjustment value based on the output control variable, and use the frequency adjustment value to adjust or scale processing frequencies in the computing device to alter the current FPS.

In response to determining that the current FPS is within the threshold range (i.e., determination block 1102=“Yes”) or after adjusting/scaling the processing frequencies in the computing device to alter the current FPS in block 1004, the computing device may determine or compute an updated current FPS value that includes any changes to the FPS due to the adjustments or scaling of the processing frequencies in block 1104. The computing device may repeat the operations in block 1102, 1002, 1004 and 1104 repeatedly to stabilize the FPS and ensure the frame rate remains within a suitable range.

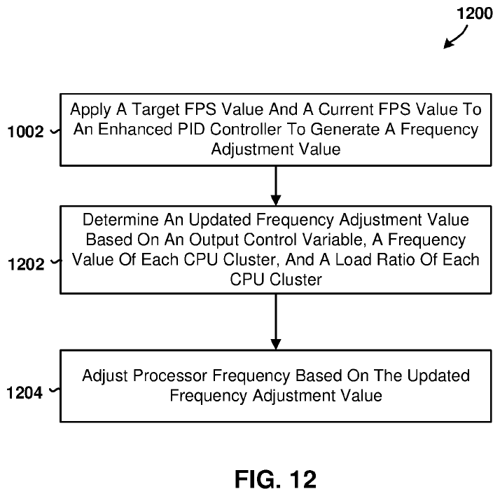

FIG. 12 illustrates a method 1200 of stabilizing FPS displayed on a computing device in accordance with some embodiments. With reference to FIGS. 1-12, the method 1200 may be performed in a computing device by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504, FPS adjustment component 602, etc.) discussed in this application. Means for performing the functions method 1200 may include any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504, FPS adjustment component 602, etc.) discussed in this application.

In block 1002 the computing device may perform the operations of block 1002 of method 1000 as described. For example, the computing device may determine an error value based on a difference between a current FPS and a target FPS, apply the error value to a proportional term/gain, integral term/gain, and derivative term/gain to obtain an output control variable, determine a frequency adjustment value based on the output control variable.

In block 1202, the computing device may determine an updated frequency adjustment value based on an output control variable, a frequency value of each CPU cluster, and a load ratio of each CPU cluster. For example, the CPUFreq component 608 may adjust the frequency of the processing units based on the frequency adjustment value, which may impact the future or current FPS generation and/or the operations of other CPU clusters. The FPS adjustment summation component 606 may use the feedback 612 from CPUFreq component 608 to repeatedly or continuously generate new updated frequency values that are sent to the CPUFreq component 608 for further updates on the same or different processing units or CPU clusters.

In block 1204 the computing device may adjust a processing frequency based on the updated frequency adjustment value. For example, the computing device may set the maximum and minimum frequency values of a CPU cluster 306 or any of the processing units (e.g., processors 110, 112, 114, 116, 118, 121, 122, 121, 122, 152, 160, 306, 310, 312, 314, processing cores 204a, 204b, 204c, 206a, 206b, 206c, etc.) discussed in this application. In some embodiments, the computing device may repeatedly perform the operations of determining an updated frequency adjustment value based on the output control variable, the frequency value of each CPU cluster, and the load ratio of each CPU cluster in block 1202, and adjusting the processing frequency based on the updated frequency adjustment value in block 1204 until the current FPS value is within a threshold range of the target FPS value.

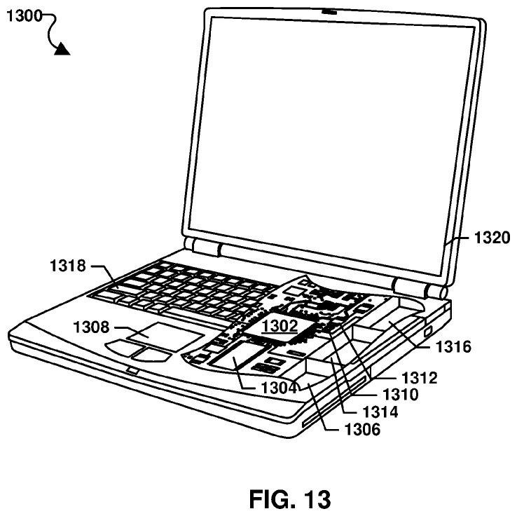

Various embodiments (including, but not limited to, embodiments described above with reference to FIGS. 1-12) may be implemented in a wide variety of wireless devices and computing systems including a laptop computer 1300, an example of which is illustrated in FIG. 13. With reference to FIGS. 1-13, a laptop computer may include a processor 1302 coupled to volatile memory 1304 and a large capacity nonvolatile memory, such as a disk drive 1306 of Flash memory. The processor 1302 may be any of the processing units (e.g., processors 110, 112, 114, 116, 118, 121, 122, 121, 122, 152, 160, 306, 310, 312, 314, processing cores 204a, 204b, 204c, 206a, 206b, 206c, SOC 102, SOC 104, etc.) discussed in this application. The laptop computer 1300 may include a touchpad touch surface 1308 that serves as the computer's pointing device, and thus may receive drag, scroll, and flick gestures. Additionally, the laptop computer 1300 may have one or more antenna 1310 for sending and receiving electromagnetic radiation that may be connected to a wireless data link and/or cellular telephone transceiver 1312 coupled to the processor 1302. The computer 1300 may also include a BT transceiver 1314, a compact disc (CD) drive 1316, a keyboard 1318, and a display 1320 all coupled to the processor 1302. Other configurations of the computing device may include a computer mouse or trackball coupled to the processor (e.g., via a Universal Serial Bus (USB) input) as are well known, which may also be used in conjunction with various embodiments.

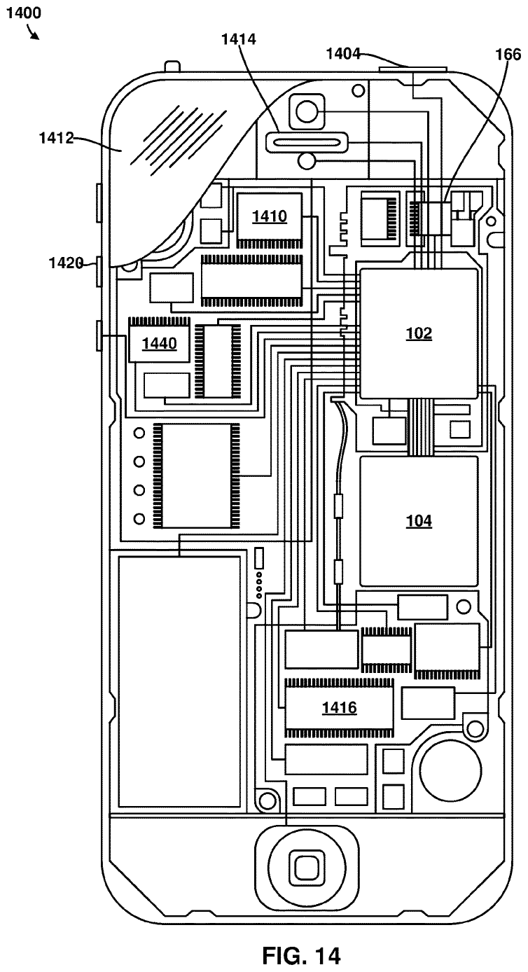

FIG. 14 is a component block diagram of a computing device 1400 suitable for use with various embodiments. With reference to FIGS. 1-14, various embodiments may be implemented on a variety of computing devices 1400, an example of which is illustrated in FIG. 14 in the form of a smartphone. The computing device 1400 may include a first SOC 102 coupled to a second SOC 104. The first and second SoCs 102, 104 may be coupled to internal memory 1416, a display 1412, and to a speaker 1414. The first and second SOCs 102, 104 may also be coupled to at least one subscriber identity module (SIM) 1440 and/or a SIM interface that may store information supporting a first 5GNR subscription and a second 5GNR subscription, which support service on a 5G non-standalone (NSA) network.

The computing device 1400 may include an antenna 1404 for sending and receiving electromagnetic radiation that may be connected to a wireless transceiver 166 coupled to one or more processors in the first and/or second SOCs 102, 104. The computing device 1400 may also include menu selection buttons or rocker switches 1420 for receiving user inputs.

The computing device 1400 also includes a sound encoding/decoding (CODEC) circuit 1410, which digitizes sound received from a microphone into data packets suitable for wireless transmission and decodes received sound data packets to generate analog signals that are provided to the speaker to generate sound. Also, one or more of the processors in the first and second circuitries 102, 104, wireless transceiver 166 and CODEC 1410 may include a digital signal processor (DSP) circuit (not shown separately).

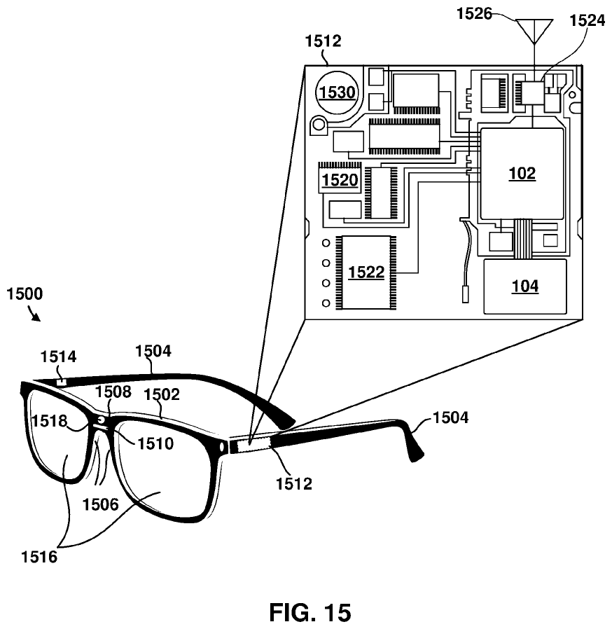

Various embodiments (including embodiments discussed above with reference to FIGS. 1-12, etc.) may be implemented on a variety of wearable devices, an example of which is illustrated in FIG. 15 in the form of smart glasses 1500. With reference to FIGS. 1-15, the glasses 1500 may operate like conventional eyeglasses, but with enhanced computer features and sensors, like a built-in camera 1518 and heads-up display or graphical features on or near the lenses 1516. Like any glasses, smart glasses may include a frame 1502 coupled to temples 1504 that fit alongside the head and behind the ears of a wearer. The frame 1502 may hold the lenses 1516 in place before the wearer's eyes when nose pads 1506 on a bridge 1508 that rests on the wearer's nose.

In some embodiments, the glasses 1500 may include an image rendering device 1514 (e.g., an image projector), which may be embedded in one or both temples 1504 of the frame 1502 and configured to project images onto the optical lenses 1516. In some embodiments, the image rendering device 1514 may include a light-emitting diode (LED) module, a light tunnel, a homogenizing lens, an optical display, a fold mirror, or other components well known projectors or head-mounted displays. In some embodiments (e.g., those in which the image rendering device 1514 is not included or used), the optical lenses 1516 may be or may include, see-through or partially see-through electronic displays. In some embodiments, the optical lenses 1516 include image-producing elements, such as see-through Organic Light-Emitting Diode (OLED) display elements or liquid crystal on silicon (LCOS) display elements. In some embodiments, the optical lenses 1516 may include independent left-eye and right-eye display elements. In some embodiments, the optical lenses 1516 may include or operate as a light guide for delivering light from the display elements to the eyes of a wearer.

The glasses 1500 may include a number of external sensors that may be configured to obtain information about the wearer's actions and external conditions that may be useful for sensing images, sounds, muscle motions, and other phenomena that may be useful for detecting when the wearer is interacting with a virtual user interface as described. In some embodiments, the glasses 1500 may include a camera 1518 configured to image objects in front of the wearer in still images or a video stream, which may be transmitted to another computing device for analysis. In some embodiments, the glasses 1500 may include a microphone 1510 positioned and configured to record sounds in the vicinity of the wearer. In some embodiments, multiple microphones may be positioned in different locations on the frame 1502, such as on a distal end of the temples 1504 near the jaw, to record sounds made when a user taps a selecting object on a hand, and the like. In some embodiments, the glasses 1500 may include pressure sensors, such as on the nose pads 1506, configured to sense facial movements for calibrating distance measurements.

The processing system 1512 may include any or all of the processing units (e.g., processors 110, 112, 114, 116, 118, 121, 122, 121, 122, 152, 160, 306, 310, 312, 314, processing cores 204a, 204b, 204c, 206a, 206b, 206c, etc.) discussed in this application. The processing and communications SOC 102, 104 may be coupled to internal sensors 1520, internal memory 1522, and communication circuitry 1524 coupled one or more antenna 1526 for establishing a wireless data link with an external computing device (e.g., remote server, etc.), such as via a Bluetooth or Wi-Fi link. The processing system 1512 may include a power source such as a rechargeable battery 1530 coupled to the processing units and the external sensors on the frame 1502.

As discussed above, some embodiments may include methods and computing devices configured to stabilize a software application's frames per second (FPS) characteristics on a computing device. The methods may include applying a target FPS value and a current FPS value to a Proportional-Integral-Derivative (PID) controller to generate a frequency adjustment value and adjusting a processing frequency based on the frequency adjustment value. Said another way, the methods may include determining a target FPS, determining the current FPS, using a proportional-integral-derivative (PID) control unit to find a frequency adjustment value based on the target and current FPS, and dynamically scaling the clock frequency or processing frequency of one or more processors or resources within the computing device based on the frequency adjustment value. By leveraging the PID component, these embodiments may ensure that the current FPS stays within a target range without significantly affecting the power consumption characteristics of the device.

Further embodiments may include methods and computing devices configured to control power in the computing device based on a stable FPS. The embodiment methods may include maintaining power within an appropriate range to prolong device usage time, reduce heat, and/or improve an overall game experience. These embodiments may improve the power consumption characteristics of the device and/or further reduce FPS fluctuations with little or no user-perceivable impact on the performance of the device or software application. Some embodiments may use a PID control component to automatically adjust the target FPS when the target power is high.

In some embodiments, the methods may include a processor obtaining a target power value (target_power), determining a power difference value (Δpower) based on the difference between the target power value and a current power value, determining the variation in the target FPS, generating an updated target FPS value based on the current target FPS and the variation in the target FPS, determining a performance value, adjusting the current FPS based on the performance value, and adjusting the current power based on the current FPS. These operations may be performed repeatedly or continuously to stabilize or modulate FPS and maintain power consumption within acceptable thresholds while enhancing the device's or application's stability, power, and performance characteristics.

Some embodiments may use the combination of power control and FPS control in a cascaded PID loop to further enhance the device's or software application's stability and/or performance. A cascaded PID loop may include multiple PID controllers organized hierarchically so that the output of one PID controller is used as the input (or set point) for a subsequent PID controller. This cascaded configuration may improve control or performance by reducing variability, enhancing response to disturbances, and enabling more conservative tuning of the outer loop in comparison to single-loop control systems.

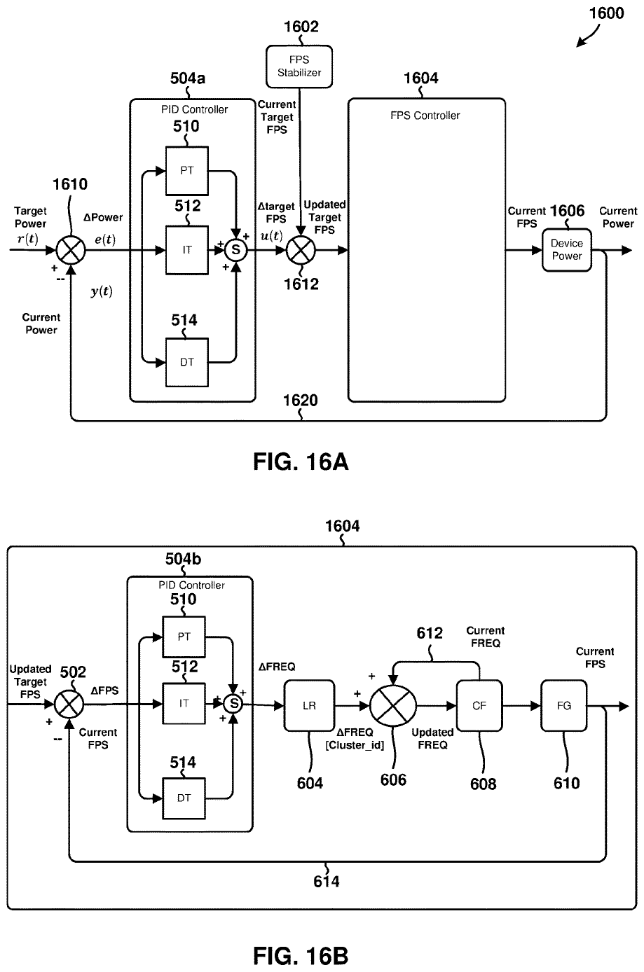

FIGS. 16A and 16B illustrate a power controller computing subsystem 1600 configured to use a cascade PID loop to control power in accordance with some embodiments. With reference to FIGS. 1-16B, the power controller computing subsystem 1600 may be included in a computing device and implemented by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.) discussed in this application.

In the example illustrated in FIG. 16A, power controller computing subsystem 1600 includes a PID controller 504a, an FPS stabilizer 1602, an FPS controller 1604, a device power 1606 component, a first set point summation component 1610, and a second set point summation component 1612. FIG. 16B illustrates components of the FPS controller 1604, which may include a summation component 502, a PID controller 504b, a load ratio (LR) component 604, FPS adjustment summation component 606, a CPU frequency (CF) component 608, and an FPS generator (FG) component 610, any or all of which may be configured to perform any or all of the operations discussed above with reference to FIGS. 5 and 6. The device power 1606 component may be a power controller configured to stabilize power by adjusting the target FPS. The FPS controller 1604 may be configured to stabilize FPS by adjusting frequency. The PID controllers 504a and 504b may be combined as a cascade PID control loop, with FPS controller 1604 including negative feedback 614 operating as an inner loop and the power controller 1600 including power feedback 1620 operating as the outer loop.

The computing subsystem 1600 may include cascade proportional-integral-derivative (PID) control components that are particularly useful for software applications associated with heavy workloads, high power consumption, consistent or sustainable FPS, and/or power consumption limitations. The cascade PID control components may include two PID controllers 504a, 504b configured or arranged so that the output of the first PID controller 504a may be used as the input or set point of the second PID controller 504b.

The use of two PID controllers 504a, 504b cascaded in accordance with the embodiments may provide several advantages, including reduced overall variability, more effective response to disturbances, and more conservative outer loop tuning. A decreased overall variability may indicate that a swifter inner loop (e.g., feedback 614) may react to disturbances faster or more rapidly than the outer loop (e.g., feedback 1620), which may reduce the impact of disturbances and restrict variability. An improved disturbance response may result in a proficient reaction to disturbances in loops that implement a cascade architecture. This is because the inner loop is not only faster than the outer loop but also closer to the disturbance source, enabling a more immediate correction of process disruptions. A more cautious outer loop tuning may allow design engineers to fine-tune the outer loop for steadier control.

In the example illustrated in FIG. 16A, the first setpoint ( ) may be the target power, the first process variable ( ) may be the current power, the first error value ( ) may be the difference between the target power and current power (Δpower), and the first output control variable ( ) may be the variation in the target FPS (Δtarget FPS).

The PID controller 504a may receive the error signal value (( )=Δpower) as an input and generate an output control variable (( )) based on the target FPS variation (Δtarget FPS). The summation component 1608 may sum the output of the PID controller 504a (Δtarget FPS) and the output of FPS stabilizer 1602 (current target FPS) to generate an updated target FPS value that is input to the FPS controller 1604. The FPS controller 1604 may be configured to receive the updated target FPS value as an input and generate a current FPS as an output. The device power component 1606 may be configured to receive the current FPS as an input and adjust the power to generate a current power value (e.g., ( )) as an output.

Thus, the computing subsystem 1600 may receive a target power value (e.g., ( )) as an input and generate a current power value (e.g., ( )) as an output. The target power value may represent the power required under the current application conditions or configuration. The current power value may represent the actual measured power of the application. The computing subsystem 1600 may adjust device power 1606 based on the current FPS.

With reference to FIGS. 1-16B, the FPS controller 1604 may be configured to receive the updated target FPS value as an input, determine the difference between the target FPS and current FPS (Δfps), and input the difference between the target FPS and current FPS (Δfps) to the PID controller 504b. The PID controller 504b may determine the frequency variation (Δfreq). The LR component 604 may receive the output (Δfreq) as an input, and generate an output based on the output of the PID controller 504b and a load ratio value. The load ratio component 604 may also send the output to the processors/clusters and/or perform any or all of the operations discussed above with reference to FIG. 6.

The FPS adjustment summation component 606 may sum the output of the LR component 604 and a performance value (e.g., frequency adjustment value, etc.) that is determined based on the output (Δfreq). The FPS adjustment summation component 606 may output the summation result as an updated frequency value to the CF component 608. The CF component 608 may generate a performance value and/or perform any or all of the operations discussed above with reference to FIG. 6. The FPS generator component 610 may receive as an input the performance value from the CF component 608, adjust the current FPS based on the received performance value, and/or perform any or all of the operations discussed above with reference to FIG. 6.

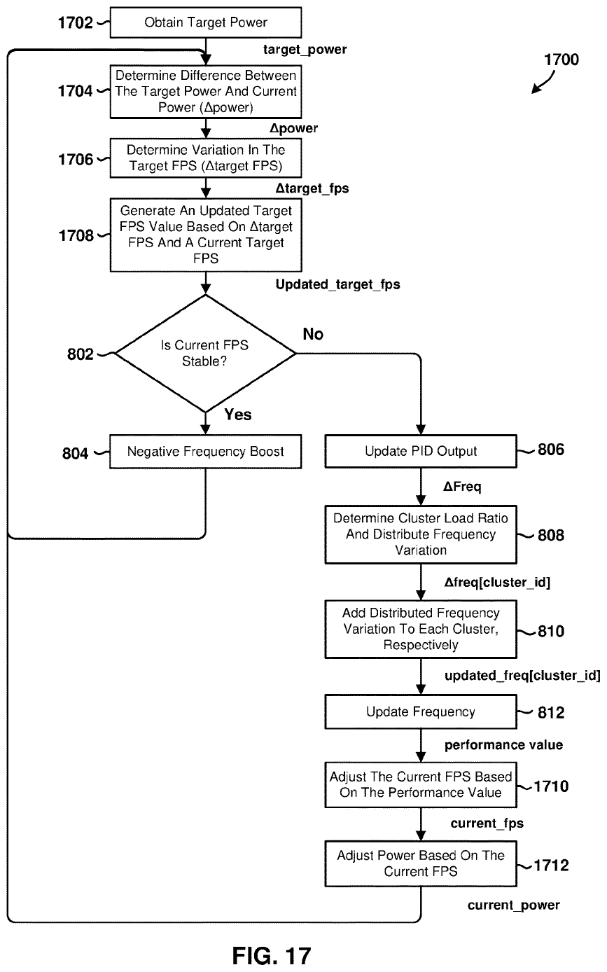

FIG. 17 illustrates a method 1700 of adjusting power based on the current FPS in a computing device in accordance with some embodiments. With reference to FIGS. 1-17, the method 1700 may be performed in a computing device by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504a, 504b, FPS adjustment component 602, FPS controller 1604, etc.) discussed in this application. Means for performing the functions method 1700 may include any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504a, 504b, FPS adjustment component 602, FPS controller 1604, etc.) discussed in this application.

In block 1702, the processor may obtain a target power value (target_power). In some embodiments, the target power value may identify a level of power at which the computing device or software application is to operate. In some embodiments, the target power may be determined based on hardware capabilities, energy efficiency goals, performance requirements, etc. In some embodiments, the target power may be a predetermined value. In some embodiments, the target power may be identified or requested by a software application executing on the computing device. In some embodiments, the target power may be determined by the computing device as the power necessary to support the operational requirements of a software application executing on the computing device.

In block 1704, the processor may determine a power difference value (Δpower) based on the difference between the target and current power values. The current power value may be a value that represents the real-time power consumption of the device or application, in contrast to the target power that is a level of power at which the computing device or software application should operate. As such, the power difference value (Δpower) may identify how much the actual power usage of the computing device deviates from the desired or target power value. In some embodiments, the processor may determine the power difference value (Δpower) by subtracting the current power value from the obtained target power. A positive power difference value (Δpower) may indicate that the device currently uses less power than the target power and/or may indicate that there is room for performance improvements without exceeding the target power. A negative power difference value (Δpower) may indicate that the current power consumption exceeds the target power and/or that power reduction measures should be implemented to meet the set power targets.

In block 1706, the processor may determine variations in the target fps (Δtarget fps). As discussed above, FPS is an important variable for software applications that quantifies the speed at which a computing device displays consecutive images or frames. A higher FPS generally correlates with smoother motion in visual output at the expense of higher power consumption. A target FPS value may be a frame rate that balances tradeoffs between performance and power consumption on the computing device. The processor may monitor the actual FPS over a certain period and compare the real-time actual FPS values with the target FPS to calculate the variation or difference in the target fps (Δtarget FPS). As such, the variation in the target fps value (Δtarget FPS) may identify the discrepancy between the target and the actual frame rates.

In block 1708, the processor may generate an updated target fps value based on target fps value (Δtarget FPS) and a current target FPS (updated_target_fps). As discussed above, the target fps value (Δtarget FPS) value may indicate the difference between the desired frame rate and the actual frame rate of the device or application. The current target FPS may be a predefined frame rate value that balances various tradeoffs between performance and power consumption characteristics in the computing device. In some embodiments, the processor may compute the current target FPS value (updated_target_fps) to recalibrate the target FPS considering the device's or application's real-time performance. In some embodiments, the processor may determine whether the target fps value (Δtarget FPS) exceeds a threshold value. The processor may determine that there is a substantial discrepancy between the actual and the target FPS and/or that an adjustment may be required in response to determining that the target fps value (Δtarget FPS) exceeds the threshold value.

In blocks 802-812, the processor may perform any or all of the operations of blocks 802-812 of the method 800 as described.

In block 1710, the processor may use the performance value to adjust the current FPS (current_fps). For example, the processor may increase power consumption to improve performance or decrease power consumption to meet energy efficiency goals.

In block 1712, the processor may use the current FPS to adjust the current power (current_power). The processor may then repeat the operations in blocks 1704-1712 to stabilize or modulate FPS, maintain power consumption within acceptable thresholds, and/or otherwise improve the device or application's stability, power and/or performance characteristics.

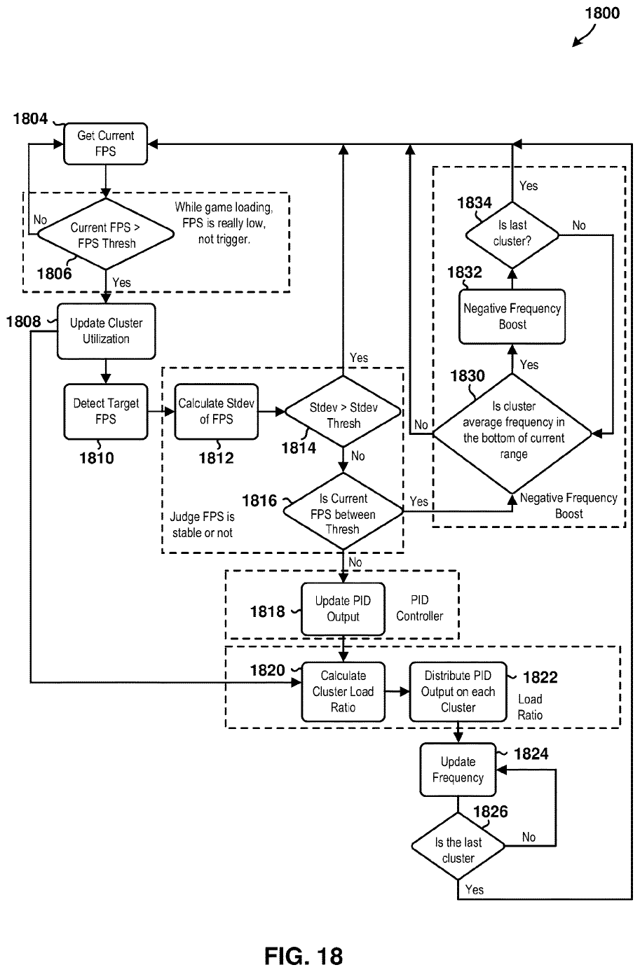

FIG. 18 illustrates a method 1800 for managing FPS in a computing device to achieve stable performance while maintaining efficient power consumption. With reference to FIGS. 1-18, the method 1800 may be performed in a computing device by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504a, 504b, FPS adjustment component 602, FPS controller 1604, etc.) discussed in this application. Means for performing the functions method 1800 may include any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504a, 504b, FPS adjustment component 602, FPS controller 1604, etc.) discussed in this application.

In block 1804, the processor may obtain the current FPS or retrieve the current FPS value. The current FPS value may be the real-time frame rate at which the device or application is currently operating. The processor may determine the current FPS value by measuring the number of frames rendered in a specific interval of time (e.g., 1 second).

In determination block 1806, the processor may determine whether the current FPS is greater than an FPS threshold. For example, the processor may compare the current FPS value to a predefined FPS threshold value to determine whether the current FPS is greater than the FPS threshold value. As another example, the computing device may invoke a compare function or determine whether the difference between the current FPS value and the threshold FPS is zero, a value greater than zero, etc.

In response to determining that the current FPS is not greater than the threshold (i.e., determination block 1806=“No”), the processor may return to block 1804 to determine an updated current FPS value.

In response to determining that the current FPS is greater than the threshold (i.e., determination block 1806=“Yes”), the processor may update cluster utilization in block 1808. That is, the processor may update the usage or utilization levels of the processing clusters in block 1808. In some embodiments, the processor may update the cluster utilization by monitoring and adjusting the distribution of computational tasks among different processing clusters within the computing device to balance the load more evenly, optimize power consumption, and/or maintain or improve system performance.

In block 1810, the processor may detect the target FPS. That is, the processor may identify the target FPS value, which may be a desired frame rate for balancing performance and power consumption characteristics on the device.

In block 1812, the processor may calculate the standard deviation of FPS. For example, the processor may calculate the standard deviation of the FPS values to assess the variability in frame rate.

In determination block 1814, the processor may determine whether the standard deviation is greater than a predefined threshold value. For example, the processor may compare the standard deviation calculated in block 1812 to a predefined threshold value stored in memory.

In response to determining that the standard deviation is greater than the predefined threshold value (determination block 1814=“Yes”), the processor may fetch an updated current FPS in block 1804. In response to determining that the standard deviation is not greater than the predefined threshold value (determination block 1814=“No”), the processor may determine whether the current FPS is between a set of threshold values in determination block 1816. For example, in determination block 1816 the processor may check to determine whether the current FPS falls within a certain range defined by two thresholds.

In response to determining that the current FPS is between the threshold values (e.g., determination block 1816=“Yes”), the processor may update the PID output in block 1818, calculate a cluster load ratio in block 1820, distribute the PID output on each cluster in block 1822, update the frequency in block 1824, and determine whether the current cluster is the last cluster in determination block 1826.

In response to determining that the current cluster is not the last cluster (i.e., determination block 1826=“No”), the processor may update the frequency in block 1824. In response to determining that the current cluster is the last cluster (i.e., determination block 1826=“Yes”), the processor may return to block 1804 to determine an updated current FPS value.

In response to determining that the current FPS is between the threshold values (e.g., determination block 1816=“No”), the processor may determine whether the cluster average frequency is in the bottom of the current range in determination block 1830.

In response to determining that cluster average frequency is not at the bottom of the current range (i.e., determination block 1830=“No”), the processor may determine an updated current FPS value in block 1804.

In response to determining that cluster average frequency is in the bottom of current range (i.e., determination block 1830=“Yes”), the processor may perform a negative frequency boost in block 1832.

In determination block 1834, the processor may determine whether the current cluster is the last cluster. In response to determining that the current cluster is not the last cluster (i.e., determination block 1834=“No”), the processor may determine whether the cluster average frequency is in the bottom of the current range in determination block 1830. The processor may perform the operations in blocks 1830-1834 until all the clusters in the system that are in within the bottom of the current frequency range have received the negative frequency boost. A negative frequency boost operation may lower the operating frequency of a processing unit to conserve power.

In response to determining that the current cluster is the last cluster (i.e., determination block 1834=“Yes”), the processor may return to block 1804 to determine an updated current FPS value.

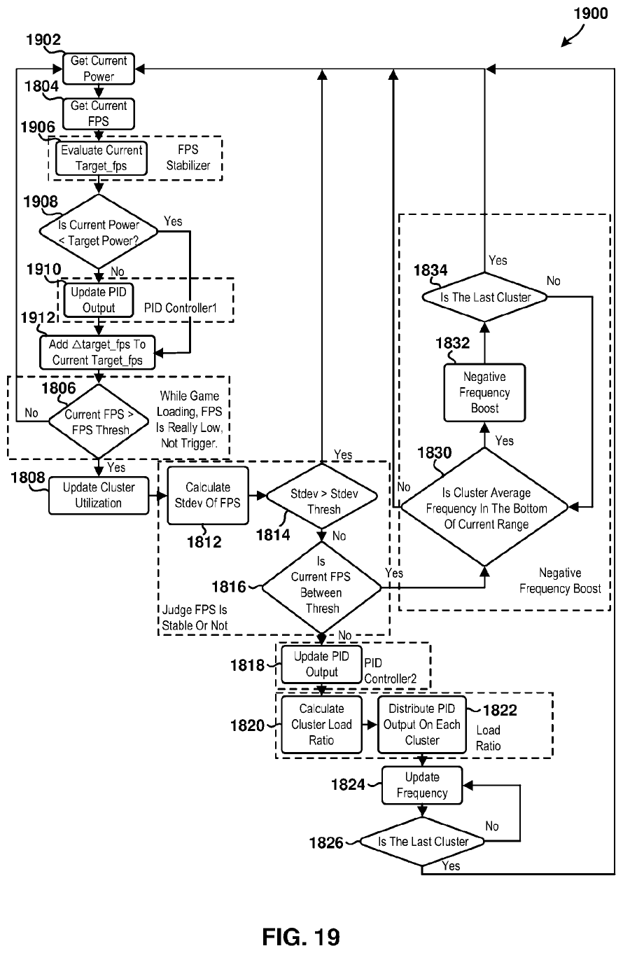

FIG. 19 illustrates another method 1900 for managing FPS in a computing device to achieve stable performance while maintaining efficient power consumption. With reference to FIGS. 1-19, the method 1900 may be performed in a computing device by any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504a, 504b, FPS adjustment component 602, FPS controller 1604, etc.) discussed in this application. Means for performing the functions method 1900 may include any or all of the processing units (e.g., processors 110, 112, 114, 116, 118, 121, 122, 121, 122, 152, 160, 306, 310, 312, 314, processing cores 204a, 204b, 204c, 206a, 206b, 206c, CPU clusters 306, etc.), computing subsystems 500, 600, or components (e.g., PID controller 504a, 504b, FPS adjustment component 602, FPS controller 1604, etc.) discussed in this application.

In block 1902, the processor may obtain or determine the current power value. The current power value may represent the actual measured power of the device or application.

In block 1804, the processor may obtain the current FPS or retrieve the current FPS value. The current FPS value may be the real-time frame rate at which the device or application is currently operating. The processor may determine the current FPS value by measuring the number of frames rendered in a specific interval of time (e.g., 1 second).

In block 1906, the processor may evaluate the current target FPS. For example, the processor may retrieve the current target FPS value from memory or a register. This value may be set by the user or determined by the system based on hardware capabilities, performance requirements, or other factors. The processor may compare the current target FPS value to the actual or real-time FPS to determine whether the system is meeting its performance goals. Given the system's constraints, the processor may also evaluate whether the current target FPS is achievable. For example, the processor may assess the device's processing power, memory, graphics capabilities, and other factors that could impact the FPS.

In determination block 1908, the processor may determine whether the current power is less than the target power.

In response to determining that the current power is not less than the target power (i.e., determination block 1908=“No”), the processor may update the PID output in block 1910. As discussed above, the PID controller is a control loop feedback mechanism widely used in control systems that calculates an error value as the difference between a desired setpoint and a measured process variable. The PID controller may reduce or minimize the error by adjusting the process control inputs.

In response to determining that the current power is not less than the target power (i.e., determination block 1908=“Yes”), the processor may add the target fps value (Δtarget FPS) to the current target FPS (updated_target_fps) in block 1912. As discussed above, the target fps value (Δtarget FPS) value may indicate the difference between the desired frame rate and the actual frame rate of the device or application.

In blocks 1806-1834, the processor may perform the operations of the like-numbered blocks of the method 1800 as described.

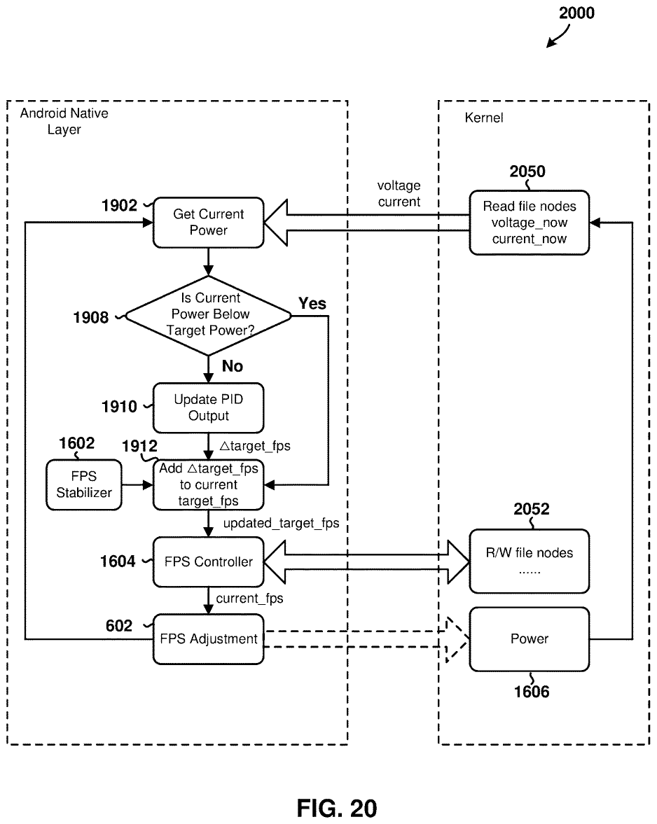

FIG. 20 illustrates components, operations, and interactions in a system configured to manage FPS in a computing device to achieve stable performance while maintaining efficient power consumption in accordance with some embodiments. With reference to FIGS. 1-20, in blocks 1902-1910, the processor in a computing device may perform the operations of the like-numbered blocks of the method 1900 as described.

In block 1912, the processor may sum the output of the PID controller 504a (Δtarget FPS) and the output of FPS stabilizer 1602 (current target FPS) to generate an updated target FPS value as an input to the FPS controller 1604. Said another way, in block 1912, the processor may add the target fps value (Δtarget FPS) to the current target FPS to generate an updated_target_fps value.

The FPS controller 1604 may be configured to stabilize FPS by adjusting the FPS frequency. The FPS controller 1604 may be configured to receive the updated target FPS value as an input and generate a current FPS as an output. The device power component 1606 may be configured to receive the current FPS as an input and adjust the power to generate a current power value (e.g., ( )) as an output. As part of these operations, the processor may read file nodes voltage_now current_now in block 2050. In block 2052, the processor may read or write file nodes and perform other similar operations.

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1: A method of stabilizing frames per second (FPS) displayed on a computing device, including applying a target FPS value and a current FPS value to a Proportional-Integral-Derivative (PID) controller to generate a frequency adjustment value, and adjusting a processing frequency based on the frequency adjustment value.

Example 2: The method of example 1 further including determining an updated current FPS value, determining whether the updated current FPS value is within a threshold range of the target FPS value, repeating operations of applying the target FPS value and the current FPS value to the PID controller to generate the frequency adjustment value, adjusting the processing frequency based on the frequency adjustment value, determining the updated current FPS value, and determining whether the updated current FPS value is within the threshold range of the target FPS value until the current FPS value is within the threshold range of the target FPS value.

Example 3: The method of any of examples 1 and 2 in which adjusting the processing frequency based on the frequency adjustment value includes setting maximum and minimum frequency values of a processing cluster.

Example 4: The method of any of examples 1-3 in which applying the target FPS value and the current FPS value to the PID controller to generate the frequency adjustment value includes determining an error value based on a difference between the current FPS value and the target FPS value, applying the error value to a proportional term, integral term, and derivative term to obtain an output control variable, and determining the frequency adjustment value based on the output control variable.

Example 5: The method of example 4 in which determining the frequency adjustment value based on the output control variable includes determining the frequency adjustment value of each processing unit based on the output control variable and a load ratio of each processing unit.

Example 6: The method of any of examples 1-5 further including determining an updated frequency adjustment value based on an output control variable, a frequency value of each processing unit, and a load ratio of each processing unit, and adjusting the processing frequency based on the updated frequency adjustment value.

Example 7: The method of any of example 6 further including repeatedly performing operations of determining the updated frequency adjustment value based on the output control variable, the frequency value of each processing unit, and the load ratio of each processing unit, and adjusting the processing frequency based on the updated frequency adjustment value until the current FPS value is within a threshold range of the target FPS value.

Example 8: A method of controlling power in a computing device based on frames per second (FPS) displayed on the computing device, including applying a target power value and a current power value to a Proportional-Integral-Derivative (PID) controller to generate a variation in target FPS (Δtarget FPS) value, adding the variation in target FPS (Δtarget FPS) value and a current target FPS value to generate an updated target FPS value as an input to an FPS controller that generates a current FPS as an output, and adjusting the power based on the current FPS output by the FPS controller.

Example 9: The method of example 8, further including applying the updated target FPS and the current FPS value to the PID controller to generate a frequency adjustment value, and adjusting a processing frequency based on the frequency adjustment value.

Example 10: The method of either of the examples 8 or 9, further including determining an updated current FPS value, determining whether the updated current FPS value is within a threshold range of the target FPS value, and repeating operations of applying the target FPS value and the current FPS value to the PID controller to generate the frequency adjustment value, adjusting the processing frequency based on the frequency adjustment value, determining the updated current FPS value, and determining whether the updated current FPS value is within the threshold range of the target FPS value until the current FPS value is within the threshold range of the target FPS value.

Example 11: The method of any of the examples 8-10, in which adjusting the processing frequency based on the frequency adjustment value includes setting maximum and minimum frequency values of a processing cluster.

Example 12: The method of any of the examples 8-11, in which applying the target FPS value and the current FPS value to the PID controller to generate the frequency adjustment value includes determining an error value based on a difference between the current FPS value and the target FPS value, applying the error value to a proportional term, integral term, and derivative term to obtain an output control variable, and determining the frequency adjustment value of each processing unit based on the output control variable and a load ratio of each processing unit.

Example 13: The method of any of the examples 8-12, further including determining an updated frequency adjustment value based on an output control variable, a frequency value of each processing unit, and a load ratio of each processing unit, and adjusting the processing frequency based on the updated frequency adjustment value.

Example 14: The method of any of the examples 8-13, further including repeatedly performing operations of determining updated frequency adjustment value based on the output control variable, the frequency value of each processing unit, and the load ratio of each processing unit, and adjusting the processing frequency based on the updated frequency adjustment value until the current FPS value is within a threshold range of the target FPS value.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium.

The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store target program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A method of controlling power in a computing device based on frames per second (FPS) displayed on the computing device, comprising:
applying a target power value and a current power value to a Proportional-Integral-Derivative (PID) controller to generate a variation in target FPS (Δtarget FPS) value;
adding the variation in target FPS (Δtarget FPS) value and a current target FPS value to generate an updated target FPS value as an input to an FPS controller that generates a current FPS as an output; and
adjusting the power based on the current FPS output by the FPS controller.

2. The method of claim 1, further comprising:
applying the updated target FPS value and a current FPS value to the PID controller to generate a frequency adjustment value; and
adjusting a processing frequency based on the frequency adjustment value.

3. The method of claim 2, further comprising:
determining an updated current FPS value;
determining whether the updated current FPS value is within a threshold range of the target FPS value; and
repeating operations of applying the target FPS value and the current FPS value to the PID controller to generate the frequency adjustment value, adjusting the processing frequency based on the frequency adjustment value, determining the updated current FPS value, and determining whether the updated current FPS value is within the threshold range of the target FPS value until the current FPS value is within the threshold range of the target FPS value.

4. The method of claim 2, wherein adjusting the processing frequency based on the frequency adjustment value comprises setting maximum and minimum frequency values of a processing cluster.

5. The method of claim 2, wherein applying the updated target FPS value and the current FPS value to the PID controller to generate the frequency adjustment value comprises:
determining an error value based on a difference between the current FPS value and the updated target FPS value;
applying the error value to a proportional term, integral term, and derivative term to obtain an output control variable; and
determining the frequency adjustment value of each processing unit based on the output control variable and a load ratio of each processing unit.

6. The method of claim 2, further comprising:
determining an updated frequency adjustment value based on an output control variable, a frequency value of each processing unit, and a load ratio of each processing unit; and
adjusting the processing frequency based on the updated frequency adjustment value.

7. The method of claim 6, further comprising repeatedly performing operations of determining updated frequency adjustment value based on the output control variable, the frequency value of each processing unit, and the load ratio of each processing unit, and adjusting the processing frequency based on the updated frequency adjustment value until the current FPS value is within a threshold range of the target FPS value.

8. A power control module for use in a computing device having a display, comprising:
a first Proportional-Integral-Derivative (PID) controller configured to receive a target power value and a current power value as input and output a variation in target frames per second (FPS) (Δtarget FPS) value;
an adder circuit coupled to the PID controller and configured to add the variation in target FPS (Δtarget FPS) value to a current target FPS value to generate an updated target FPS value;
a FPS controller coupled to the adder circuit and configured to generate a current FPS of the display of the computing device as an output; and
a device power controller coupled to the FPS controller and configured to adjust power in the computing device based on the current FPS output by the FPS controller.

9. The power control module of claim 8, wherein:
the FPS controller includes a second PID controller configured to generate a frequency adjustment value based on the updated target FPS value and a current FPS value; and
the FPS controller is further configured to adjust a processing frequency based on the frequency adjustment value.

10. The power control module of claim 9, wherein the FPS controller is further configured to:
determine an updated current FPS value;
determine whether the updated current FPS value is within a threshold range of the target FPS value; and
repeat operations of applying the target FPS value and the current FPS value to the PID controller to generate the frequency adjustment value, adjusting the processing frequency based on the frequency adjustment value, determining the updated current FPS value, and determining whether the updated current FPS value is within the threshold range of the target FPS value until the current FPS value is within the threshold range of the target FPS value.

11. The power control module of claim 9, wherein the FPS controller is further configured to adjust the processing frequency based on the frequency adjustment value by setting maximum and minimum frequency values of a processing cluster.

12. The power control module of claim 9, wherein the second PID controller is configured to apply the updated target FPS value and the current FPS value to generate the frequency adjustment value by:
determining an error value based on a difference between the current FPS value and the updated target FPS value;
applying the error value to a proportional term, integral term, and derivative term to obtain an output control variable; and
determining the frequency adjustment value of each processing unit based on the output control variable and a load ratio of each processing unit.

13. (canceled)

14. (canceled)

15. A computing device, comprising:
a processor configured to:
apply a target power value and a current power value to a Proportional-Integral-Derivative (PID) controller to generate a variation in target frames per second (FPS) (Δtarget FPS) value;
add the variation in target FPS (Δtarget FPS) value and a current target FPS value to generate an updated target FPS value as an input to an FPS controller that generates a current FPS as an output; and
adjust power in the computing device based on the current FPS output by the FPS controller.

16. The computing device of claim 15, wherein the processor is further configured to:
apply the updated target FPS value and a current FPS value to the PID controller to generate a frequency adjustment value; and
adjust a processing frequency based on the frequency adjustment value.

17. The computing device of claim 16, wherein the processor is further configured to:
determine an updated current FPS value;
determine whether the updated current FPS value is within a threshold range of the target FPS value; and
repeat operations of applying the target FPS value and the current FPS value to the PID controller to generate the frequency adjustment value, adjusting the processing frequency based on the frequency adjustment value, determining the updated current FPS value, and determining whether the updated current FPS value is within the threshold range of the target FPS value until the current FPS value is within the threshold range of the target FPS value.

18. The computing device of claim 16, wherein the processor is configured to adjust the processing frequency based on the frequency adjustment value by setting maximum and minimum frequency values of a processing cluster.

19. The computing device of claim 16, wherein the processor is configured to apply the updated target FPS value and the current FPS value to the PID controller to generate the frequency adjustment value by:
determining an error value based on a difference between the current FPS value and the updated target FPS value;
applying the error value to a proportional term, integral term, and derivative term to obtain an output control variable; and
determining the frequency adjustment value of each processing unit based on the output control variable and a load ratio of each processing unit.

20. The computing device of claim 16, wherein the processor is further configured to:
determine an updated frequency adjustment value based on an output control variable, a frequency value of each processing unit, and a load ratio of each processing unit; and
adjust the processing frequency based on the updated frequency adjustment value.

21. The computing device of claim 20, wherein the processor is further configured to repeatedly perform operations of determining the updated frequency adjustment value based on the output control variable, the frequency value of each processing unit, and the load ratio of each processing unit, and adjusting the processing frequency based on the updated frequency adjustment value until the current FPS value is within a threshold range of the target FPS value.

22. A computing device, comprising:
means for using a target power value and a current power value to generate a variation in target frames per second (FPS) (Δtarget FPS) value;
means for adding the variation in target FPS (Δtarget FPS) value and a current target FPS value to generate an updated target FPS value;
means for using the updated target FPS value to generate a current FPS; and
means for adjusting power in the computing device based on the current FPS.

23. (canceled)

24. (canceled)

25. (canceled)

26. (canceled)

27. (canceled)

28. (canceled)

29. (canceled)

30. (canceled)
